(19) United States
(12) Patent Application Publication
(10) Pub. No.: US 2022/0345978 A1
(43) Pub. Date: Oct. 27, 2022

(54) NETWORK CONTROL DEVICE, NETWORK CONTROL SYSTEM, AND NETWORK CONTROL METHOD

(71) Applicant: PANASONIC CORPORATION, Osaka (JP)

(72) Inventors: Noriyuki SHIMIZU, Kanagawa (JP); Hiroaki ASANO, Kanagawa (JP); Masahisa OKUDA, Kanagawa (JP); Yoichi NAKAGAWA, Tokyo (JP)

(73) Assignee: PANASONIC CORPORATION, Osaka (JP)

(21) Appl. No.: 17/763,939

(22) PCT Filed: Sep. 18, 2020
(86) PCT No.: PCT/JP2020/035460

§ 371 Date: Mar. 25, 2022

(30) Foreign Application Priority Data
Sep. 30, 2019 (JP) 2019-178700

(51) Int. Cl. H04W 40/12; H04W 40/24; H04L 45/122; H04W 40/08

(52) U.S. Cl. CPC H04W 40/12; H04W 40/246; H04L 45/122; H04W 40/08

(57) ABSTRACT

In a network having an edge server disposed therein, to appropriately construct a wireless communication route used in communication between the edge server and a user terminal, a processor of a network control device acquires group information related to grouped base stations in multiple base stations disposed in the network, acquires route information related to one or more wireless communication routes formed by multi-hop communication between the grouped base stations, and transmits the group information and the route information to an edge server connected to one of the base stations or to a user terminal.

### TECHNICAL FIELD

The present disclosure relates to a network control device, a network control system, and a network control method for controlling a communication route in a network.

### BACKGROUND ART

In the field of mobile network, 5G (fifth generation mobile communication system) is in the stage of commercialization, and along with this, a considerable increase in traffic is expected. Also, to cope with such an increase in traffic, use of higher frequency bands (for example, 40 GHz band, 70 GHz band) than the conventionally used frequency bands is discussed.

As the used frequency becomes higher, attenuation of the radio wave increases due to the radio wave propagation characteristics. Therefore, in the mobile communication, the service area covered by a single base station (or access point) becomes smaller, and it becomes necessary to dispose the base stations at a higher density. When the base stations are disposed at a higher density, it is assumed that a backhaul (relay line) for connecting between the base station that the user terminal accesses and the core network is realized by multi-hop communication based on wireless communication between the multiple base stations to avoid laying of communication cables as much as possible.

It is desired that such a backhaul based on wireless communication be constructed according to the arrangement, communication state, and the like of each base station. Therefore, for example, there is known a technology in which a base station is connected to another base station by using a wireless communication route utilizing a millimeter wave band, and information related to the backhaul is notified by being included in the system information, so that the backhaul is flexibly constructed (see Patent Document 1).

### PRIOR ART DOCUMENT(S)

### Patent Document(s)

[Patent Document 1] WO2018/096839A1

### SUMMARY OF THE INVENTION

### Task to be Accomplished by the Invention

Incidentally, in a next generation communication system such as 5G, it is considered that a so-called local production for local consumption type network, in which generation and use of data and information as well as transmission and reception thereof are completed within a specific area, may become necessary. Therefore, an increase in traffic related to the data and information that can be effectively utilized in only the specific area is expected. As such data and information, for example, output (detection result) from sensors of manufacturing facilities in a smart factory, videos of intersections and other detection information in a next generation ITS (Intelligent Transport System), and the like can be conceived.

Also, to increase the information processing speed and optimize the traffic in the specific area, it is important to perform distributed processing based on edge computing technology.

Therefore, in such a local production for local consumption type network, the wireless communication route needs to be optimized according to the arrangement of edge servers in the network around the user terminal from the viewpoint of maintenance of QoS (Quality of Service), improvement of electric power efficiency, and the like.

However, with the conventional technology as described in the aforementioned Patent Document 1, a backhaul passing fewer base stations is constructed, for example, but arrangement of the edge servers is not taken into account in the construction of the backhaul. Therefore, with the aforementioned conventional technology, it is not ensured that a wireless communication route appropriate for communication between a user terminal and an edge server in a local production for local consumption type network is constructed.

In view of the above, a primary object of the present disclosure is to provide a network control device, a network control system, and a network control method which, in a network having an edge server disposed therein, can appropriately construct a wireless communication route used in the communication between the edge server and the user terminal.

### Means to Accomplish the Task

A network control device of the present disclosure is a network control device comprising a processor that executes a process for controlling a communication route between an edge server and a user terminal in a network, wherein the network comprises multiple base stations and the edge server is connected to one of the base stations, and wherein the processor acquires group information related to grouped base stations in the multiple base stations, acquires route information related to one or more wireless communication routes formed by multi-hop communication between the grouped base stations, and transmits the group information and the route information to the edge server or the user terminal.

Also, a network control system of the present disclosure comprises the aforementioned network control device, the multiple base stations, and the one or more edge servers.

Also, a network control method of the present disclosure is a network control method for controlling a communication route between an edge server and a user terminal in a network, wherein the network comprises multiple base stations and the edge server is connected to one of the base stations, the method comprising: acquiring group information related to grouped base stations of the multiple base stations; acquiring route information related to one or more wireless communication routes formed by multi-hop communication between the grouped base stations; and transmitting the group information and the route information to the edge server or the user terminal.

### Effect of the Invention

According to the present disclosure, it is possible, in a network having an edge server disposed therein, to appropriately construct a wireless communication route used in the communication between the edge server and the user terminal.

### BRIEF DESCRIPTION OF THE DRAWINGS

FIG. 1 is an overall configuration diagram of a network control system according to the first embodiment;

FIG. 2 is an explanatory diagram showing an example of control of a communication route between a user terminal and an edge server by a NW control server;

FIG. 3 is a block diagram showing a schematic configuration of an access point;

FIG. 4 is a block diagram showing a schematic configuration of the edge server;

FIG. 5 is a block diagram showing a schematic configuration of the NW control server;

FIG. 6 is a block diagram showing a schematic configuration of the user terminal;

FIG. 7 is a sequence diagram showing a procedure of a communication route construction operation in the network control system;

FIG. 8 is an explanatory diagram showing an example of surrounding equipment information;

FIG. 9 is an explanatory diagram showing an example of information for route establishment;

FIG. 10 is an explanatory diagram showing an example of arrangement and grouping of the access points;

FIG. 11 is an explanatory diagram showing an example of construction of communication routes in the network shown in FIG. 10;

FIG. 12 is an explanatory diagram showing an example of an operation to connect the user terminal to the edge server in the network shown in FIG. 10;

FIG. 13 is a sequence diagram showing a procedure of an operation to connect the user terminal to the edge server in the network control system;

FIG. 14 is an explanatory diagram showing an example of (A) group information, (B) connection target priority degree information, and (C) service area information;

FIG. 15 is a flowchart showing a flow of processing in the NW control server shown in FIG. 7 and FIG. 13;

FIG. 16 is a flowchart showing details of a backhaul route construction process in ST103 of FIG. 15;

FIG. 17 is a flowchart showing a flow of processing in each access point shown in FIG. 7;

FIG. 18 is a flowchart showing a flow of processing in the edge server shown in FIG. 7;

FIG. 19 is a flowchart showing a flow of processing in the user terminal shown in FIG. 13;

FIG. 20 is an explanatory diagram showing an example of activation control of an alternative edge server by the network control system according to the second embodiment;

FIG. 21 is a sequence diagram showing a procedure of an activation operation of the alternative edge server in the network control system;

FIG. 22 is an explanatory diagram showing an example of alternative edge server information;

FIG. 23 is a flowchart showing a flow of processing in the NW control server shown in FIG. 21;

FIG. 24 is an explanatory diagram showing an example of access point addition control by the network control system according to the third embodiment;

FIG. 25 is a sequence diagram showing a procedure of an access point addition operation by the network control system;

FIG. 26 is an explanatory diagram showing an example of revised group information;

FIG. 27 is a flowchart showing a flow of processing in the NW control server shown in FIG. 25;

FIG. 28 is a flowchart showing details of a determination process on whether the communication route may be changed in ST702 of FIG. 27;

FIG. 29 is an explanatory diagram showing an example of a network in a specific area to which the network control system according to the fourth embodiment is applied;

FIG. 30 is a sequence diagram showing a procedure of activation and stop operations of the access points in the network control system;

FIG. 31 is a flowchart showing a flow of processing in the access point shown in FIG. 30;

FIG. 32 is a flowchart showing a flow of processing in the edge server shown in FIG. 30;

FIG. 33 is a flowchart showing a flow of processing in the NW control server shown in FIG. 30;

FIG. 34 is an explanatory diagram showing group information updated in ST1106 of FIG. 33;

FIG. 35 is a flowchart showing a flow of activation and stop control of the access point in ST1105 of FIG. 33;

FIG. 36 is an explanatory diagram showing an example of traffic distribution in the access points; and

FIG. 37 is an explanatory diagram showing an example of a relationship between a minimum delay time and a standby mode in each access point.

### MODE(S) FOR CARRYING OUT THE INVENTION

A first aspect of the invention to solve the above problem is a network control device comprising a processor that executes a process for controlling a communication route between an edge server and a user terminal in a network, wherein the network comprises multiple base stations and the edge server is connected to one of the base stations, and wherein the processor acquires group information related to grouped base stations in the multiple base stations, acquires route information related to one or more wireless communication routes formed by multi-hop communication between the grouped base stations, and transmits the group information and the route information to the edge server or the user terminal.

According to this, in a network having an edge server disposed therein, it is possible to appropriately construct a wireless communication route used in the communication between the edge server and the user terminal by using the group information and the route information transmitted from the network control device to the edge server or the user terminal.

In a second aspect of the invention, the processor acquires wireless quality information related to quality of wireless communication between each pair of base stations in the multiple base stations, position information of each base station, and edge server information related to presence or absence of the edge server connected to each base station, and generates the group information and the route information based on the wireless quality information, the position information, and the edge server information.

According to this, the network control device can easily generate the group information and the route information based on the wireless quality information, the position information, and the edge server information.

In a third aspect of the invention, the route information includes information related to multiple wireless communication routes, and the processor acquires connection target priority degree information related to a priority degree of a connection target of the user terminal set according to a type of service of the edge server used by the user terminal and transmits the connection target priority degree information to the user terminal.

According to this, even when there are multiple wireless communication routes that can be used in the communication with the edge server, the user terminal can select an appropriate connection target of the wireless communication based on the connection target priority degree information.

In a fourth aspect of the invention, the processor transmits, to the user terminal, service area information related to a distance from the base station set in accordance with the type of service of the edge server used by the user terminal.

According to this, the user terminal can easily extract the base stations qualifying as candidates for its connection target thereof based on service area information.

In a fifth aspect of the invention, the processor acquires traffic information of a wireless communication route used in communication between the edge server and the user terminal, and updates the group information based on the traffic information.

According to this, the group information is appropriately updated according to the traffic information of the wireless communication route between the base stations used in the communication between the edge server and the user terminal.

In a sixth aspect of the invention, the processor generates the route information so as to minimize a number of hops between the grouped base stations according to a type of service of the edge server used by the user terminal.

According to this, the number of hops between the base stations is suppressed, whereby the user terminal can stably use the service for which low latency should be given priority.

In a seventh aspect of the invention, the processor generates the route information to maximize electric power efficiency of communication using the wireless communication route according to a type of service of the edge server used by the user terminal.

According to this, excellent electric power efficiency is ensured in the communication, whereby the user terminal can stably use the service for which a communication volume should be given priority.

In an eighth aspect of the invention, the processor acquires traffic information of a wireless communication route used in communication between the edge server and the user terminal, and when it is determined, based on the traffic information, that an alternative edge server which can be an alternative to the edge server is connected to another base station other than the grouped base stations, activates an application program that can be used by the user terminal on the alternative edge server.

According to this, the user terminal can use the applications on the alternative edge server positioned around it, and therefore, the degree of freedom in selection of the wireless communication route is improved.

In a ninth aspect of the invention, the processor acquires traffic information of a wireless communication route used in communication between the edge server and the user terminal, and when it is determined, based on the traffic information, that another base station other than the grouped base stations is used in the communication between the edge server and the user terminal, adds the another base station to the grouped base stations.

According to this, it is possible to appropriately set the group of base stations used in the communication between the edge server and the user terminal based on the traffic information in the past communication between the edge server and the user terminal.

In a tenth aspect of the invention, the processor acquires traffic information of a wireless communication route used in communication between the edge server and the user terminal, and transmits an activation command for activating and stopping the grouped base stations to the edge server based on the traffic information.

According to this, it is possible to appropriately activate or stop the base stations forming the wireless communication route used in the communication between the edge server and the user terminal, thereby to reduce the power consumption at each base station.

An eleventh aspect of the invention is a network control system comprising the network control device according to any one of the aforementioned first to tenth aspects of the invention, the multiple base stations, and the one or more edge servers.

According to this, in a network having an edge server disposed therein, it is possible to appropriately construct a wireless communication route used in the communication between the edge server and the user terminal by using the group information and the route information transmitted from the network control device to the edge server or the user terminal.

A twelfth aspect of the invention is a network control method for controlling a communication route between an edge server and a user terminal in a network, wherein the network comprises multiple base stations and the edge server is connected to one of the base stations, the method comprising: acquiring group information related to grouped base stations of the multiple base stations; acquiring route information related to one or more wireless communication routes formed by multi-hop communication between the grouped base stations; and transmitting the group information and the route information to the edge server or the user terminal.

According to this, in a network having an edge server disposed therein, it is possible to appropriately construct a wireless communication route used in the communication between the edge server and the user terminal by using the group information and the route information transmitted from the network control device to the edge server or the user terminal.

In the following, embodiments of the present disclosure will be described with reference to the drawings.

### First Embodiment

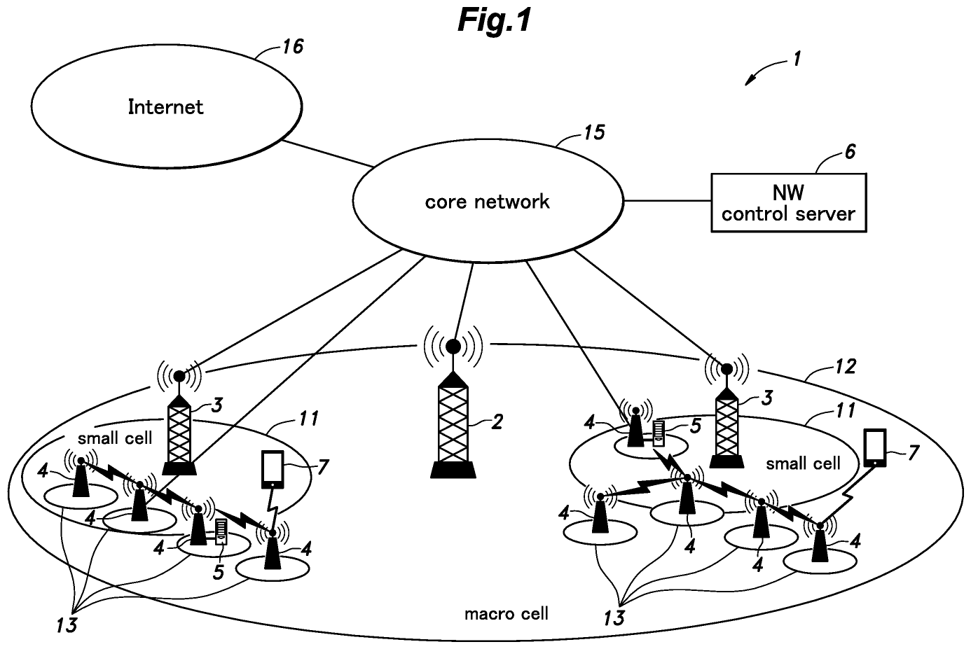

FIG. 1 is an overall configuration diagram of a network control system 1 according to the first embodiment.

The network control system 1 (simply referred to as the system 1) includes a macro cell base station 2, small cell base stations 3, access points (or base stations) 4, edge servers 5, a network control server (simply referred to as a NW control server 6) 6, and user terminals 7.

In the network in which the system 1 is applied, small cell areas 11, which are communication areas of the multiple small cell base stations 3, are overlappingly provided on a macro cell area 12, which is a communication area of the macro cell base station 2.

The macro cell base station 2 is configured to perform wireless communication by using a frequency band with which it is easy to construct a large cell, such as the UHF band (frequency: 300 MHz to 3 GHz) for LTE (Long Term Evolution), for example. The macro cell base station 2 functions as a base station of a control plane (CPlane) for transmitting control signals. Also, in some cases the macro cell base station 2 may be used as a base station of a user plane (U-Plane) for transmitting user data.

The small cell base station 3 is configured to perform wireless communication by using frequencies higher than the those used in the macro cell base station 2, such as the low SHF band (frequency: 3 GHz to 6 GHz), for example. Note that the small cell base station 3 may use the high SHF band (frequency: 6 GHz to 30 GHz band). The small cell base station 3 is used as a base station of a user plane.

The access point 4 is configured to perform relatively small volume wireless communication by Wi-Fi (registered trademark) or relatively large volume wireless LAN communication by WiGig (registered trademark), for example. The communication area 13 of the access point 4 is superimposed on at least one of the small cell area 11 and the macro cell area 12.

Note that the access point 4 may be a micro cell base station that performs wireless communication by using a frequency band higher than that of the small cell base station 3. In this case, the wireless communication by the access point 4 can be performed by using the high SHF band or the EHF band (here, 28 GHz band, 40 GHz band, and 70 GHz band, etc.) for 5G NR (New Radio). Also, the multiple access points 4 may include such micro cell base stations and base stations that perform wireless LAN communication. When a micro cell base station is used as an access point 4, the communication area 13 corresponds to the micro cell which is the communication area of the micro cell base station.

In the system 1, a so-called heterogeneous network, which is a communication environment in which multiple RATs (Radio Access Technologies) are mixedly present, is configured. The macro cell base station 2, the small cell base stations 3, and some of the access points 4 are connected by wire to a wired network constituted of a core network 15 and the Internet 16. The core network 15 includes the MME (Mobility Management Entity), the S-GW (Serving Gateway), and the P-GW (Packet data network Gateway) configuring the EPC (Evolved Packet Core) corresponding to the core network of LTE, AMF (Access and Mobility Management Function) and UPF (User Plane Function) configuring the SGC (5G Core network) corresponding to the core network of 5G, and the like. Also, in the system 1, the number and arrangement of the macro cell base station 2, the small cell base stations 3, the access points 4, the edge servers 5, the NW control server 6, and the user terminals 7 may be changed as appropriate.

Each edge server 5 executes various applications (programs) as services provided to the user terminals 7 when the user terminals 7, which are mobile, are physically near. The arrangement of each edge server 5 is not particularly limited, but here, the edge server 5 is connected to one of the access points 4.

The NW control server (the network control device) 6 controls the communication route used in the communication between the edge server 5 and the user terminal 7 in the network to which the system 1 is applied. The NW control server 6 is connected to the core network 15. Note that the NW control server 6 may configure a part of the core network 15 or may be connected to the Internet 16.

The user terminals 7 are information devices, such as smartphones and tablet terminals, which have a wireless communication function and are carried by respective users (not shown in the drawings). Each user terminal 7 can wirelessly connect to any of the macro cell base station 2, the small cell base stations 3, and the access points 4. Also, the user terminal 7 can use the applications on the edge server 5 by communicating with the edge server 5 via the macro cell base station 2, the small cell base stations 3, and the access points 4. The user terminal 7 may also communicate with any server (not shown in the drawings) via the wired network constituted of the core network 15 and the Internet 16 to use the applications on the server.

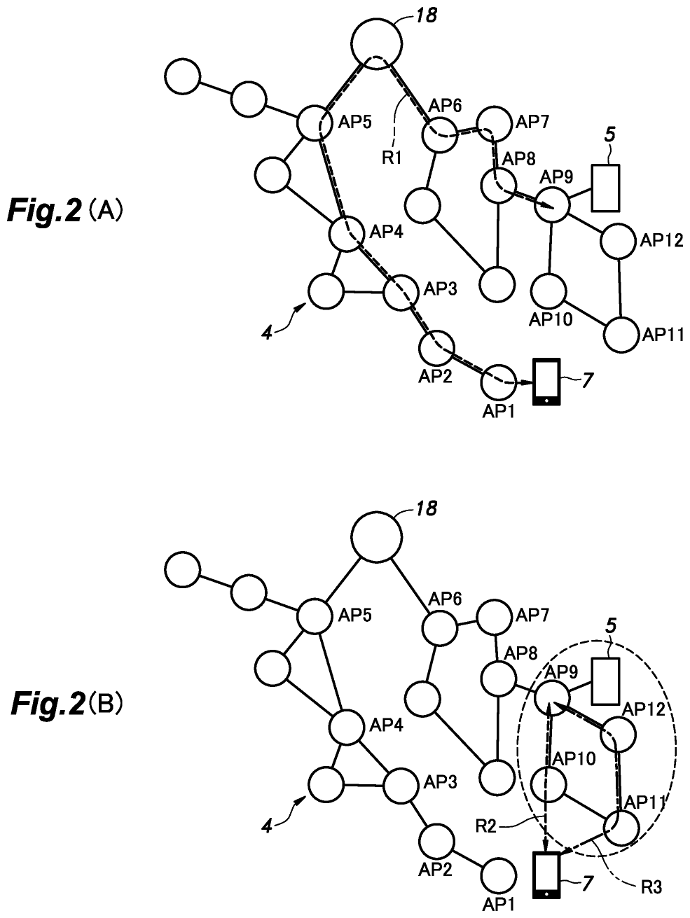

FIG. 2 is an explanatory diagram showing an example of control of the communication route between the user terminal 7 and the edge server 5 by the NW control server 6. FIG. 2(A) shows a conventional communication route (comparative example) and FIG. 2(B) shows communication routes constructed by the NW control server 6.

In FIG. 2, multiple access points 4 are arranged in a tree shape or a mesh shape from a connection point 18 of the wired network. The access points 4 are mutually connected via wireless communication to form a backhaul. Note that in FIG. 2, to distinguish the access points 4 from each other, reference signs AP1-AP12 are added.

FIG. 2(A) shows an example in which, in the communication between the user terminal 7 and the edge server 5, an access point is selected according to the wireless quality. In this case, the user terminal 7 selects the nearby access point AP1 that provides the highest wireless quality as a connection target, and as a result, it is necessary to communicate with the edge server 5 via many access points AP1-AP9. In FIG. 2(A), the backhaul for connecting each access point to the connection point 18 of the wired network is used in the communication route R1 between the user terminal 7 and the edge server 5.

In contrast, in FIG. 2(B), the multiple access points AP9-AP12 including the access point AP9 to which the edge server 5 is connected are grouped (see the broken line circle in the drawing). Also, the NW control server 6 forms wireless communication routes R2, R3 with the grouped access points AP9-AP12. Further, the NW control server 6 decides the connection target priority degrees of the access points such that the wireless communication routes R2, R3 are used preferentially and provides it to the user terminal 7. Thereby, the user terminal 7 can select the access point AP10 or AP11 as the connection target and use the wireless communication route R2 or R3 to communicate with the edge server 5.

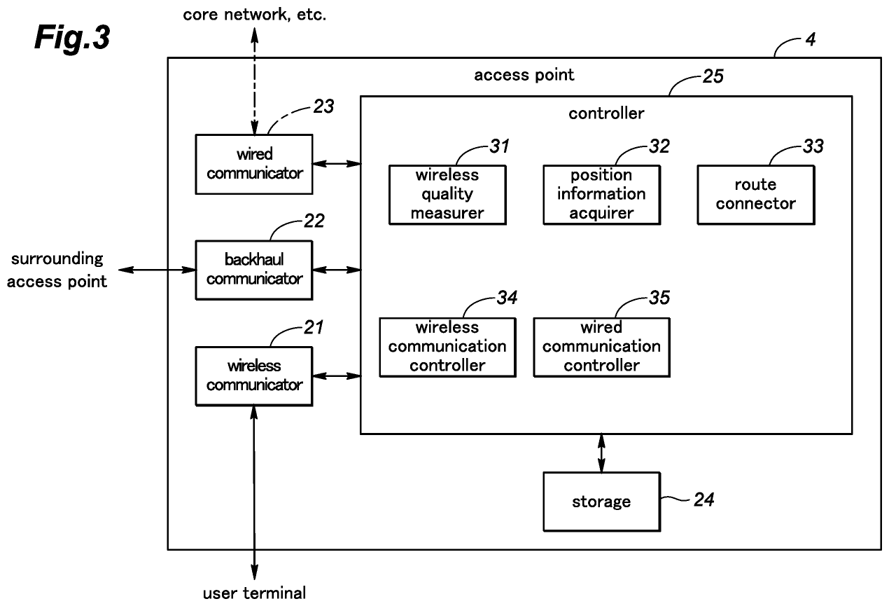

FIG. 3 is a block diagram showing a schematic configuration of the access point 4.

The access point 4 includes a wireless communicator 21, a backhaul communicator 22, a wired communicator 23, a storage 24, and a controller 25.

The wireless communicator 21 includes an antenna and a communication circuit for performing wireless communication with the user terminal 7.

The backhaul communicator 22 includes an antenna and a circuit for performing wireless communication with surrounding access points 4. Thereby, multi-hop communication by multiple access points 4 is performed so that a wireless communication route used in the communication between the user terminal 7 and the edge server 5 is formed.

The wired communicator 23 includes a communication circuit for performing wired communication with the core network 15. Note that the wired communicator 23 does not necessarily have to be provided in the all access points 4 and may be provided in the nearby access point 4 in the wired network as necessary.

The storage 24 stores information related to the user terminal 7, information related to the macro cell base station 2, the small cell base stations 3, and other access points 4 present therearound, programs executed by a processor configuring the controller 25, and so on.

The controller 25 includes a wireless quality measurer 31, a position information acquirer 32, a route connector 33, a wireless communication controller 34, and a wired communication controller 35.

The wireless quality measurer 31 measures the quality of the wireless communication with other surrounding access points 4 based on a known index such as the reception signal strength. Also, the wireless quality measurer 31 generates wireless quality information based on the measurement result of the quality of the wireless communication.

The position information acquirer 32 acquires the position information of itself (the access point 4). The position information acquirer 32 may acquire the position information by measuring the position of the own device at appropriate times or may use the position information pre-stored in the storage 24 or the like.

The route connector 33 establishes the communication route used in the communication between the user terminal 7 and the edge server 5 based on a route establishment instruction received from the edge server 5. When establishing the communication route, the route connector 33 controls the wireless communication performed by the backhaul communicator 22 to realize the multi-hop communication with the surrounding access points.

The wireless communication controller 34 controls the wireless communication with the user terminal 7 by the wireless communicator 21.

The wired communication controller 35 controls the communication performed by the wired communicator 23. Also, the wired communication controller 35 can exchange information related to the connection target of the user terminal 7 and the like by wired communication with the communication controller in the wired network, the macro cell base station 2 and the small cell base stations 3 located therearound, etc.

Note that at least some of the functions of various parts of the above-described controller 25 can be realized by execution of predetermined control programs by one or more processors.

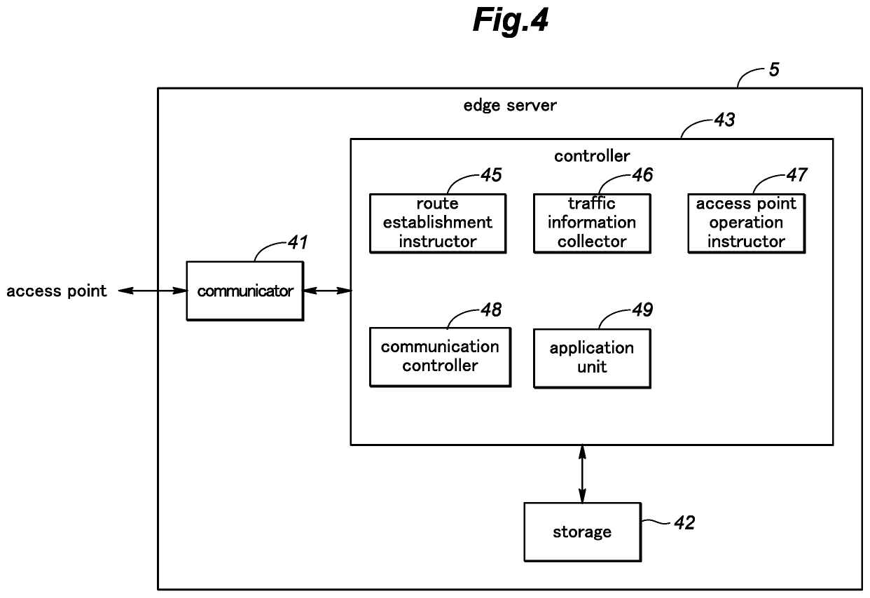

FIG. 4 is a block diagram showing a schematic configuration of the edge server 5.

The edge server 5 includes a communicator 41, a storage 42, and a controller 43.

The communicator 41 includes a communication circuit for performing communication with the access point 4 to which the own device is connected.

The storage 42 stores information related to the user terminals 7, information related to the macro cell base station 2, the small cell base stations 3, and the access points 4 located therearound, programs executed by a processor configuring the controller 43, and so on.

The controller 43 includes a route establishment instructor 45, a traffic information collector 46, an access point operation instructor 47, a communication controller 48, and an application unit 49.

The route establishment instructor 45 transmits the route establishment instruction for making the access points 4 establish the communication route based on the information (later-described group information, route information, etc.) received from the NW control server 6.

The traffic information collector 46 collects information on the traffic between the access points 4 forming the wireless communication route in relation to the communication between the user terminal 7 and the edge server 5. Note that the traffic information collector 46 may be omitted as appropriate.

The access point operation instructor 47 transmits an operation instruction to the access points 4 based on the information (later-described access point activation/stop information and the like) received from the NW control server 6. Such an operation instruction includes instruction of activation or stop of each access point 4. Note that the access point operation instructor 47 may be omitted as appropriate.

The communication controller 48 controls the communication performed by the communicator 41. Also, the communication controller 48 exchanges necessary information with the access points 4 and the user terminals 7 therearound.

The application unit 49 executes various applications according to the service contents to the user terminal 7. The processes performed by the applications include, for example, storage or provision of outputs (detection results) of the sensors installed in a smart factory, storage or provision of traffic videos or other detection information at intersections and the like, etc.

Note that at least some of the functions of various parts of the above-described controller 43 can be realized by execution of predetermined control programs by one or more processors.

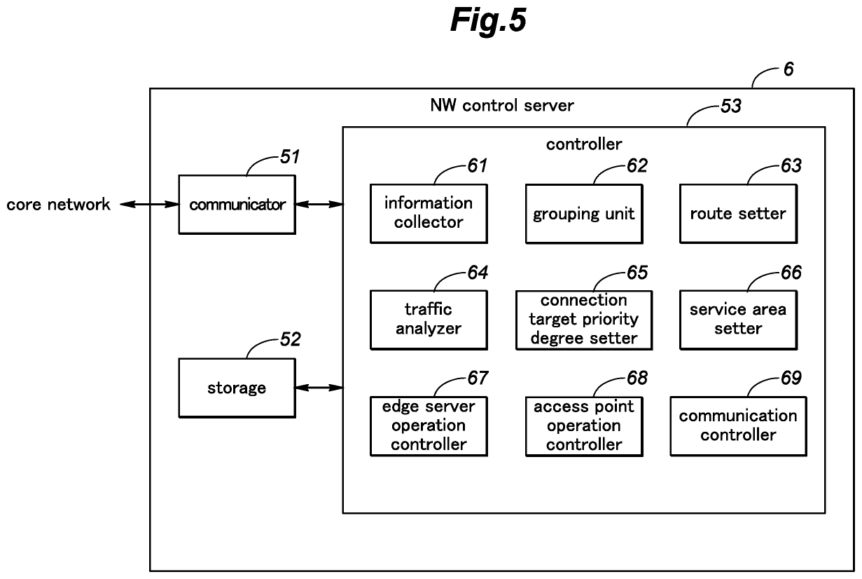

FIG. 5 is a block diagram showing a schematic configuration of the NW control server 6.

The NW control server 6 includes a communicator 51, a storage 52, and a controller (processor) 53.

The communicator 51 includes a communication circuit for performing communication with the edge servers 5 and the user terminals 7 via the core network 15.

The storage 52 stores information related to the user terminals 7, information related to the macro cell base station 2, the small cell base stations 3, and the access points 4 located therearound, programs executed by a processor configuring the controller 53, and so on.

The controller 53 includes an information collector 61, a grouping unit 62, a route setter 63, a traffic analyzer 64, a connection target priority degree setter 65, a service area setter 66, an edge server operation controller 67, an access point operation controller 68, and a communication controller 69.

The information collector 61 collects surrounding equipment information from each access point 4. This surrounding equipment information includes wireless quality information related to the quality of wireless communication between each pair of access points 4, position information of each access point 4, and edge server information related to presence or absence of the edge server 5 connected to each access point 4.

Based on the collected surrounding equipment information, the grouping unit 62 extracts access points 4 constituting a network in a specific area(s) from among the multiple access points 4 under management, and groups the extracted access points 4. Thereby, at least one group of access points 4 is generated. The “specific areas” may include, for example, an inside of a smart factory, a predetermined region including an intersection, and the like. Note that at least a part of the group of access points 4 may be set by an operator. Also, the grouping unit 62 can reconfigure the existing groups of access points 4 based on the traffic analysis result obtained by the traffic analyzer 64 described later.

The route setter 63 sets one or more wireless communication routes used in the communication between the user terminal 7 and the edge server 5. Such a wireless communication route is formed by multi-hop communication of the grouped access points 4. Note that at least a part of such a wireless communication route may be set by an operator.

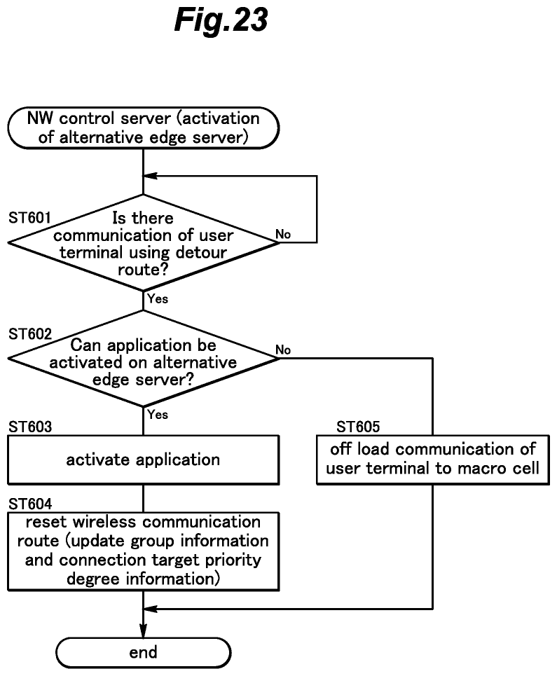

The traffic analyzer 64 sequentially acquires pieces of traffic information of the wireless communication route(s) used in the communication between the user terminal 7 and the edge server 5 from the edge server 5. These pieces of traffic information acquired are accumulated in the storage 52. Also, based on the accumulated pieces of traffic information, the traffic analyzer 64 performs analysis of the traffic such as prediction of the distribution of traffic of the wireless communication route(s) set by the route setter 63, for example. As described later, the traffic analyzer 64 can also detect a detour route that uses an access point(s) 4 outside (or not included in) the target group (see step ST601 in FIG. 23, for example).

The connection target priority degree setter 65 sets priority degrees of candidates for the connection target of the user terminal 7 according to the type of service of the edge server 5 used by the user terminal 7. Also, the connection target priority degree setter 65 generates connection target priority degree information based on the set priority degrees of the candidates for the connection target. Each candidate for the connection target of the user terminal 7 typically is one of the access points 4, but the macro cell base station 2 and the small cell base station 3 can be a candidate for the connection target as necessary. Also, the connection target priority degree information includes the priority order of each candidate for the connection target. The present invention is not limited to this, and the connection target priority degree information may include information related to the standard (rule) for deciding the priority order of each candidate for the connection target, for example.

The service area setter 66 sets a service area (the range of the communication area) of each access point 4 based on the surrounding equipment information from each access point 4. Such a service area is set according to the type of service of the edge server 5 used by the user terminal 7. Also, the service area setter 66 generates service area information related to the range of the set service area. Note that at least part of the service area information may be set by an operator.

The edge server operation controller 67 controls operation of the edge servers 5 including activation of applications in the edge servers 5.

The access point operation controller 68 controls operation of the access points 4 including activation and stop of the access point 4.

The communication controller 69 controls the communication performed by the communicator 51. Also, the communication controller 69 can exchange necessary information with the access points 4, the edge servers 5, and the user terminals 7 therearound.

Note that at least some of the functions of various parts of the above-described controller 53 can be realized by execution of predetermined control programs by one or more processors.

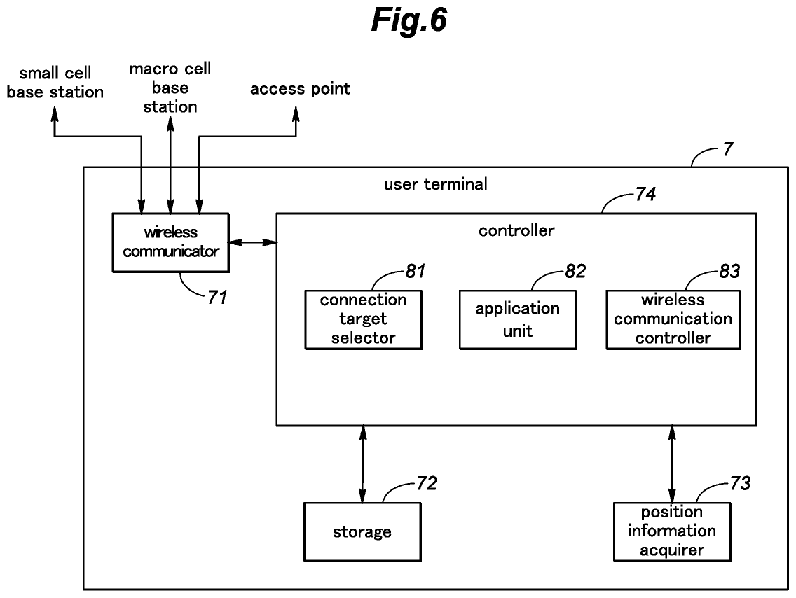

FIG. 6 is a block diagram showing a schematic configuration of the user terminal 7.

The user terminal 7 includes a wireless communicator 71, a storage 72, a position information acquirer 73, and a controller 74.

The wireless communicator 71 includes an antenna and a communication circuit for performing wireless communication with the access point 4. Also, the wireless communicator 71 includes an an antenna and a communication circuit for performing wireless communication with the macro cell base station 2 and the small cell base station 3.

The storage 72 stores information related to the own device, information related to the macro cell base station 2, the small cell base stations 3, and the access points 4 located therearound, programs executed by a processor configure the controller 74, and so on.

The position information acquirer 73 acquires position information of the own device by means of a known positioning system such as the GPS (Global Positioning System) or a system using a beacon transmitter.

The controller 74 includes a connection target selector 81, an application unit 82, and a wireless communication controller 83.

The connection target selector 81 selects a connection target, such as an access point 4, based on grouping information, connection target priority degree information, and service area information received from the NW control server 6. Thereby, the user terminal 7 can communicate with the edge server 5 via the selected connection target and the wireless communication route including it.

The application unit 82 executes processing according to the content of the application executed on the user terminal 7 and transmits and receives application data to and from the edge server 5 via the wireless communicator 71.

The wireless communication controller 83 controls the wireless communication with the access point 4, the macro cell base station 2, and the small cell base station 3 by the wireless communicator 71.

Note that at least some of the functions of various parts of the above-described controller 74 can be realized by execution of predetermined control programs by one or more processors.

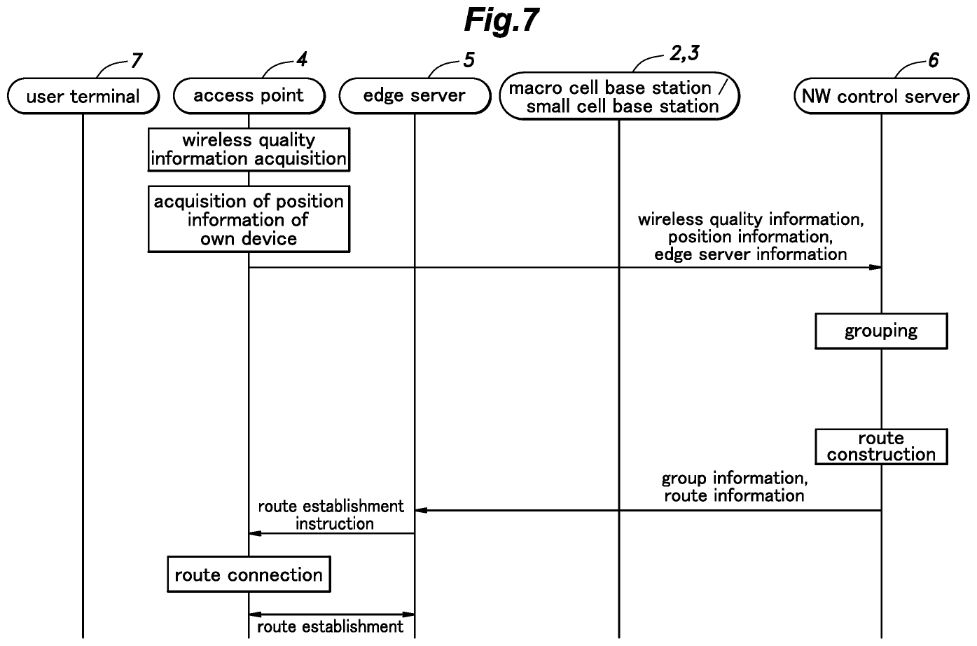

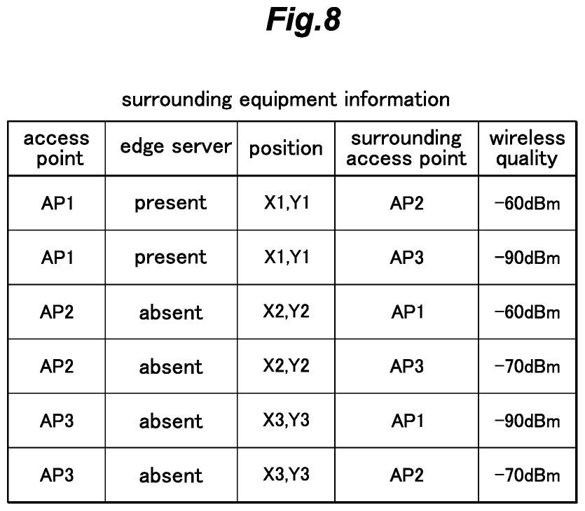

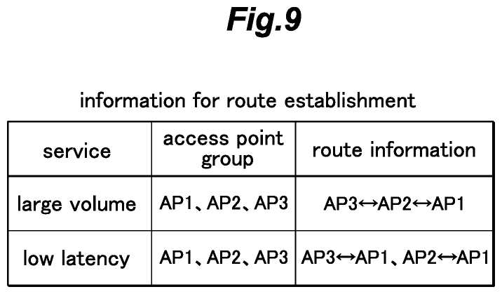

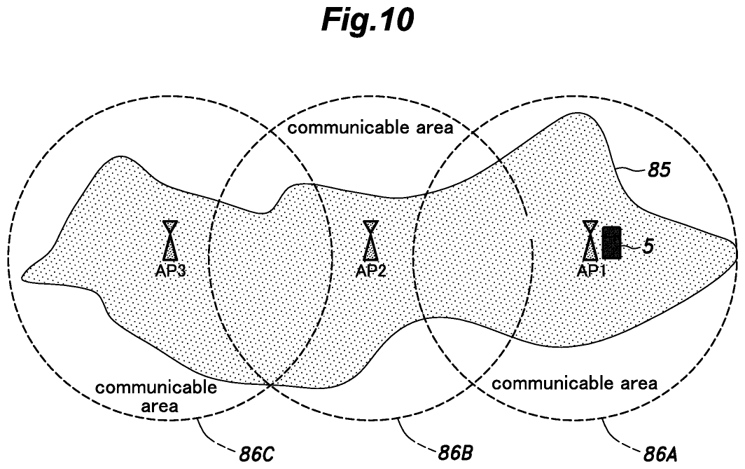

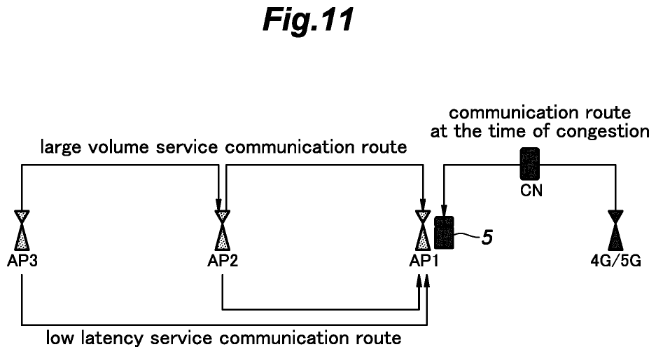

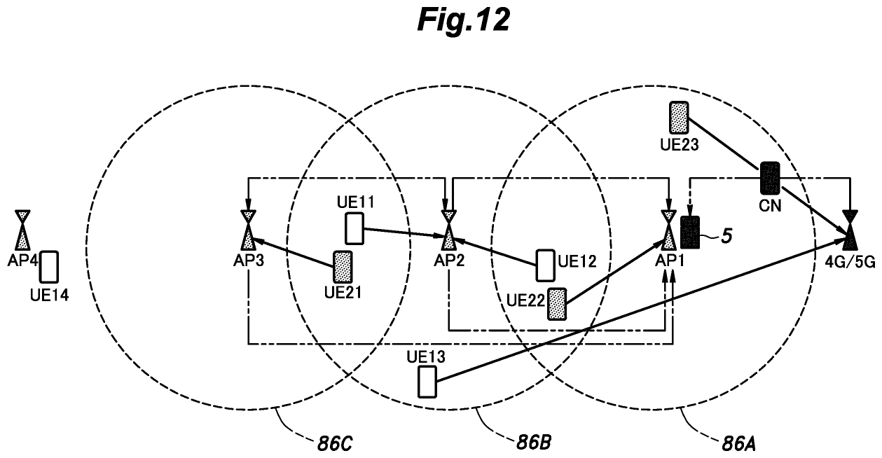

FIG. 7 is a sequence diagram showing a procedure of a communication route construction operation in the system 1. FIG. 8 is an explanatory diagram showing an example of surrounding equipment information acquired by the NW control server 6. FIG. 9 is an explanatory diagram showing an example of information for route establishment generated by the NW control server 6. FIG. 10 is an explanatory diagram showing an example of arrangement and grouping of the access points 4. FIG. 11 is an explanatory diagram showing an example of construction of communication routes in the network shown in FIG. 10. FIG. 12 is an explanatory diagram showing an operation to connect the user terminal 7 to the edge server 5 in the network shown in FIG. 10.

As shown in FIG. 7, in the system 1, each access point 4 measures the wireless quality with each of the other access points 4 around the own device and thereby acquires the wireless quality information. Also, each access point 4 acquires the position information of the own device. The wireless quality information and the position information obtained thereby are transmitted to the NW control server 6 as the surrounding equipment information together with the edge server information related to the presence or absence of the edge server 5 connected to the own device.

As shown in FIG. 8 for example, the surrounding equipment information includes the identifier of each access point 4 (here, AP1-AP3), the presence or absence of the edge server 5 connected to each access point 4, the position of each access point 4 (for example, coordinate (X1, Y1)), the identifiers of other surrounding access points 4 around each access point 4, and the wireless quality with each surrounding access point 4 (for example, −60 dBm).

Thereafter, the NW control server 6 performs grouping of the access points 4 based on the surrounding equipment information. This grouping is performed according to a service provision area assumed in the specific area. As shown in FIG. 10, for example, the grouped access points 4 (indicated by reference signs AP1-AP3 in FIG. 10) are disposed to cover an assumed service provision area 85 with with their communicable areas 86A-86C. Also, the edge server 5 is connected to at least one (see the access point AP1 in FIG. 10) of the grouped access points 4.

Subsequently, the NW control server 6 constructs one or more wireless communication routes used in the communication between the user terminal 7 and the edge server 5 in relation to the grouped access points 4. At this time, the NW control server 6 can set priority degrees for multiple candidates for the connection target configuring the constructed wireless communication route(s). The priority degrees are set based on QoS (Quality of Service) including the electric power efficiency and the number of hops, for example.

In the construction of the wireless communication route(s) by the NW control server 6, as shown in FIG. 11 for example, when the type of service of the edge server 5 used by the user terminal 7 is a large volume service for which a communication volume per unit time should be given priority, wireless communication routes are set between the access point AP3 and the access point AP2 and between the access point AP2 and the access point AP1. In other words, for the large volume service, the wireless communication routes are set such that the electric power efficiency becomes higher.

On the other hand, when the type of service of the edge server 5 used by the user terminal 7 is a low latency service for which low latency (namely, small time lag of communication) should be given priority, wireless communication routes are set between the access point AP3 and the access point AP1 and between the access point AP2 and the access point AP1. In other words, for the low latency service, the wireless communication routes are set to make the number of hops between the access points smaller.

Note that when congestion occurs, the wireless communication routes for the large volume service and for the low latency service may not be used. Therefore, the NW control server 6 can set, as a communication route at the time when congestion occurs, a communication route passing via the macro cell base station 2 or the small cell base station 3 (indicated by reference sign 4G/5G in FIG. 11). In this case, the user terminal 7 connects to the macro cell base station 2 or the small cell base station 3 and communicates with the edge server 5 (the access point AP1) via the core network 15 (indicated by reference sign CN in FIG. 11).

The group information related to the grouped access points 4 and the route information related to the one or more wireless communication routes set by the route setter 63 are transmitted to the edge server 5 as information for route establishment used in establishment of the communication route.

As shown in FIG. 9 for example, the information for route establishment includes the types of service of the edge server 5 that can be used by the user terminal 7 (here, large volume, low latency), the identifiers of the grouped access points 4 (here, AP1-AP3), and the route information. In FIG. 9, it is shown that for the large volume service, a wireless communication route is set between AP3 and AP1 with the access point AP2 being a relay point. Also, it is shown that for the low latency service, wireless communication routes are set between the access points AP3 and AP1 as well as between the access points AP2 and AP1.

The edge server 5 transmits the route establishment instruction to the access points 4 based on the group information and the route information from the NW control server 6.

Upon receipt of the route establishment instruction from the edge server 5, each access point 4 performs wireless connection with another access point 4 around it to establish the communication route with the edge server 5.

Note that the NW control server 6 may omit the above-described transmission of the information for route establishment (including the group information and the route information) to edge server 5 and may transmit similar information for route establishment to the user terminal 7. Such transmission of the information for route establishment to the user terminal is effective, for example, in a case where in the system 1, the position of the edge server 5 and at least a part of the wireless communication routes between the access points 4 are decided beforehand (or fixed). This is similarly effective in such cases as when there is no room in the system 1 to change the wireless communication routes between the access points 4 (for example, the wireless communication routes are uniquely determined based on the wireless qualities between the access points 4), for example.

As shown in FIG. 12 for example, connection of each user terminal 7 with the access point 4 is performed according to the position of the user terminal 7. In FIG. 12, the user terminals 7 that use the large volume service are denoted by reference signs UE11-UE14. Also, the user terminals 7 that use the low latency service are denoted by reference signs UE21-UE23.

The user terminal UE11 is positioned in both the communicable areas 86B and 86C of the access points AP2 and AP3, and therefore, can be connected to either of the access points AP2 and AP3. However, since the user terminal UE11 uses a large volume service, the user terminal UE11 is preferentially connected to the access point AP2 which results in a better electric power efficiency.

Similarly, the user terminal UE21 can be connected to either of the access points AP2 and AP3. However, since the user terminal UE21 uses a low latency service, the user terminal UE21 is preferentially connected to the access point from which the number of hops to the edge server 5 (the access point AP1) is smaller. In this case, the number of hops is the same between AP2 and AP3, and therefore, the user terminal UE21 is preferentially connected to the access point AP3 which results in a better electric power efficiency.

Also, the user terminal UE12 is positioned in both the communicable areas 86A and 86B of the access points AP1 and AP2, and therefore, can be connected to either of the access points AP1 and AP2. However, since the user terminal UE12 uses a large volume service, the user terminal UE12 is preferentially connected to the access point AP2 which results in a better electric power efficiency.

Similarly, the user terminal UE22 can be connected to either of the access points AP1 and AP2. However, since the user terminal UE22 uses a low latency service, the user terminal UE22 is preferentially connected to the access point AP1 from which the number of hops to the edge server 5 (the access point AP1) is smaller.

The user terminal UE13 can be connected to only the access point AP2. However, in the case shown here, congestion occurs in the communication via the access point AP2. Therefore, the user terminal UE13 is preferentially connected to the macro cell base station 2 or the small cell base station 3 (indicated by reference sign 4G/5G in FIG. 12).

Similarly, the user terminal UE23 can be connected to only the access point AP1. However, in the case shown here, congestion occurs in the communication via the access point AP1. Therefore, the user terminal UE23 is preferentially connected to the macro cell base station 2 or the small cell base station 3.

Note that the user terminal UE14 is not positioned in any of the communicable areas 86A-86C of the access points AP1-AP3. In this case, the user terminal UE14 is connected to an access point AP4 belonging to another group or is connected to the macro cell base station 2 or the small cell base station 3.

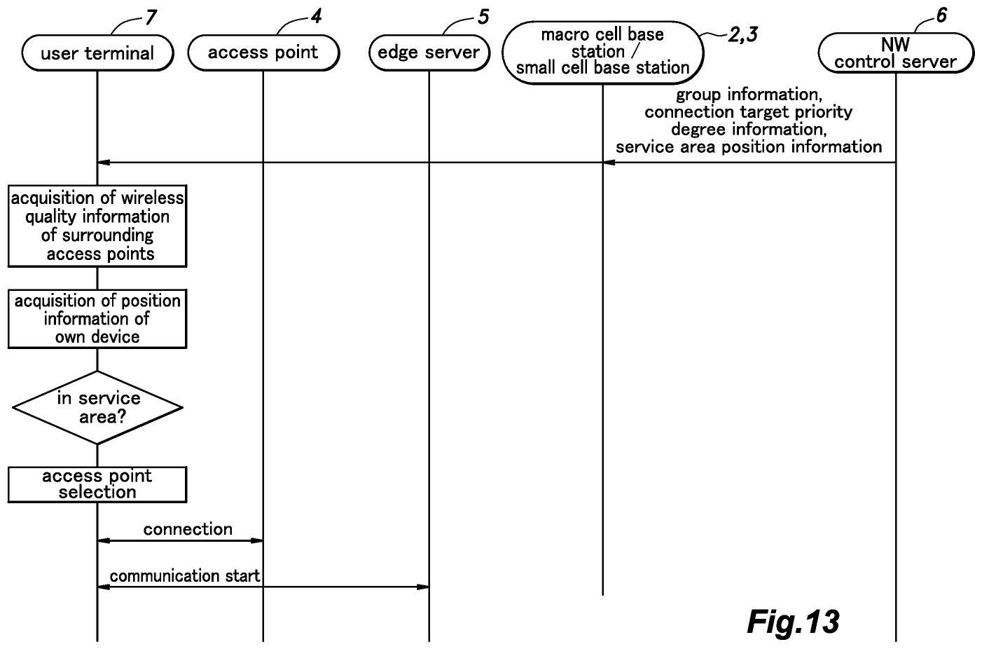

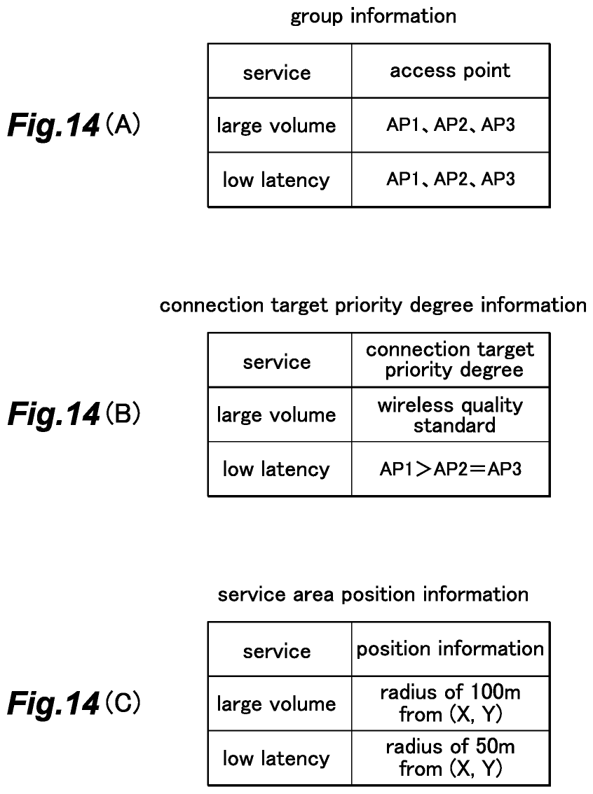

FIG. 13 is a sequence diagram showing a procedure of an operation to connect the user terminal 7 to the edge server 5 in the system 1. FIG. 14 is an explanatory diagram showing an example of (A) the group information, (B) the connection target priority degree information, and (C) the service area information.

As shown in FIG. 13, in the case where the user terminal 7 communicates with the edge server 5, the NW control server 6 transmits the group information, the connection target priority degree information, and the service area information to the user terminal 7 via the macro cell base station 2 or the small cell base station 3.

As shown in FIG. 14(A) for example, the group information includes the types of service of the edge server 5 that can be used by the user terminal 7 (here, large volume, low latency) and the identifiers (here, AP1-AP3) of the access points 4 configuring the groups corresponding to them.

The connection target priority degree information is generated according to the QoS (Quality of Service). As shown in FIG. 14(B) for example, the connection target priority degree information includes the types of service of the edge server 5 that can be used by the user terminal 7 and the priority order of each candidate for the connection target or information related to the standard (rule) for deciding the priority order of each candidate for the connection target corresponding to them. In FIG. 14(B), it is shown that for the large volume service, the connection target candidate (typically, the nearest access point) is selected according to the wireless quality. Also, it is shown that for the low latency service, the priority order of the access point AP1 is the highest, and the access points AP2 and AP3 are present with the next priority order.

As shown in FIG. 14(C) for example, the service area information indicates the types of service of the edge server 5 that can be used by the user terminal 7 and information on the ranges of the service areas of the access points 4 corresponding to them. In FIG. 14(C), it is shown that for the large volume service, the range of the service area is within the radius of 100 m from the position (X, Y) of the access point 4. Also, it is shown that for the low latency service, the range of the service area is within the radius 50 m from the position (X, Y) of the access point 4.

Upon receipt of the group information, the connection target priority degree information, and the service area information, the user terminal 7 measures the wireless quality with each of the access points 4 around it thereby to acquire the wireless quality information, and further, measures the position of the own device thereby to acquire the position information.

Subsequently, the user terminal 7 extracts one or more access points 4 with which the user terminal 7 can communicate with a wireless quality greater than or equal to a constant value, and when the own device is in the service area of the extracted access point(s) 4, selects a single access point 4 as the connection target based on the connection target priority degree information. At this time, in the case where the user terminal 7 extracted only one access point 4 and the own device is in the service area of the access point 4, the user terminal 7 selects this access point 4 regardless of the connection target priority degree information. Note that the extraction of the access point(s) 4 by the user terminal 7 is performed regularly at a predetermined period.

Thereafter, the user terminal 7 connects to the access point 4 selected as the connection target and starts the communication with the edge server 5 via a communication route including that access point 4. As this communication route, the wireless communication route constructed by the operation shown in FIG. 7 is used. Here, if there are multiple wireless communication routes that can be used, a single wireless communication route is selected according to the type of service of the edge server 5 used by the user terminal 7.

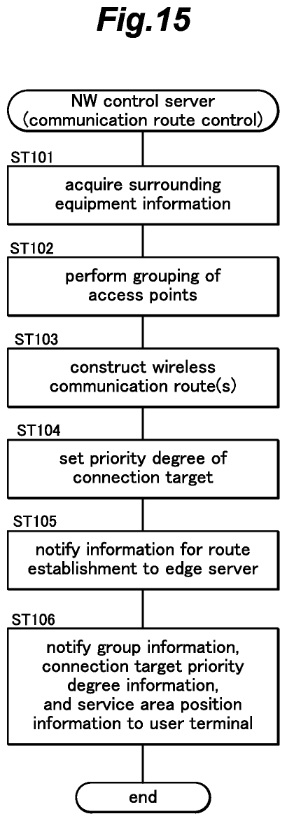

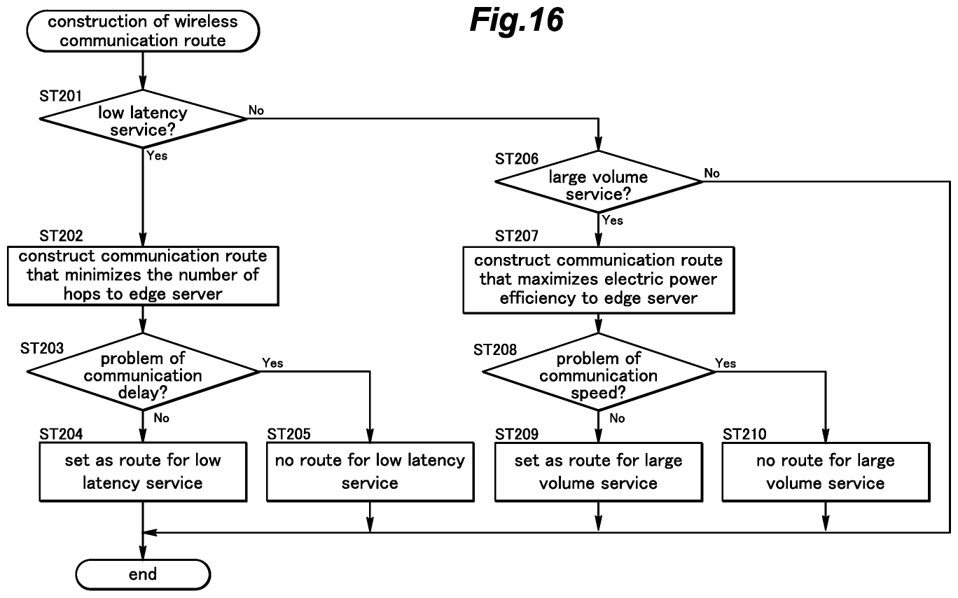

FIG. 15 is a flowchart showing a flow of processing in the NW control server 6 shown in FIG. 7 and FIG. 13. FIG. 16 is a flowchart showing details of the wireless communication route construction process in ST103 of FIG. 15.

The NW control server 6 sequentially acquires pieces of surrounding equipment information from the respective access points AP (ST101).

Thereafter, the NW control server 6 performs grouping of the access points 4 based on the pieces of surrounding equipment information acquired, (ST102). Thereby, group information including information of the grouped access points 4 is generated.

Subsequently, the NW control server 6 constructs one or more wireless communication routes used in the communication between the user terminal 7 and the edge server 5 (ST103). Thereby, route information including information of the constructed wireless communication route(s) is generated.

Further, the NW control server 6 sets the priority degree of each connection target candidate according to the required quality of the service of the edge server 5 used by the user terminal 7 (ST104). Thereby, connection target priority degree information including information of the priority degrees of the candidates for the connection target is generated.

Thereafter, the NW control server 6 transmits the generated group information and route information to the edge server 5 as the information for route establishment (ST105). At this time, as described above, the NW control server 6 may transmit the information for route establishment to the user terminal 7 instead of transmitting it to the edge server 5. Note that the NW control server 6 may transmit the information for route establishment to both of the edge server 5 and the user terminal 7.

Further, the NW control server 6 notifies the generated group information, route information, and service area information to the user terminal 7 (ST106). The NW control server 6 may repeatedly execute the aforementioned series of steps.

Also, in the aforementioned step ST103, the NW control server 6 executes the process shown in FIG. 16.

First, when the low latency service is used by the user terminal 7 (ST201: Yes), the NW control server 6 constructs a communication route so as to minimize the number of hops to the edge server 5 (ST202).

Subsequently, the NW control server 6 determined whether there is a problem of communication delay in the route constructed in step ST202 (ST203). At this time, when the communication delay time of the constructed route is less than or equal to a preset threshold value, the NW control server 6 determines that there is not a problem of communication delay. On the other hand, when the communication delay time exceeds the threshold value, the NW control server 6 determines that there is a problem of communication delay.

When there is not a problem of communication delay in the route constructed in step ST202 (ST203: No), the NW control server 6 sets the route as the route for the low latency service (ST204). On the other hand, when there is a problem of communication delay in the route constructed in ST202 (ST203: Yes), the NW control server 6 determines that there is no route for the low latency service (ST205).

Also, when the large volume service is used instead of the low latency service by the user terminal 7 (ST206: Yes), the NW control server 6 constructs a communication route so as to maximize the electric power efficiency to the edge server (ST207).

Subsequently, the NW control server 6 determines whether there is a problem of communication speed in the route constructed in step ST206 (ST208). At this time, when the communication speed of the constructed route is greater than or equal to a preset threshold value, the NW control server 6 determines that there is not a problem of communication speed. On the other hand, when the communication speed is less than the threshold value, the NW control server 6 determines that there is a problem of communication speed.

When there is not a problem of communication speed in the route constructed in ST206 (ST208: No), the NW control server 6 sets the route as the route for the large volume service (ST209). On the other hand, when there is a problem of communication delay in the route constructed in ST206 (ST208: Yes), the NW control server 6 determines that there is no route for the large volume service (ST210).

Note that FIG. 16 shows the case where the types of service that can be used by the user terminal 7 include only the low latency service and the large volume service, but the present invention is not limited to this, and when there is another type of service, the NW control server 6 can likewise set a wireless communication route.

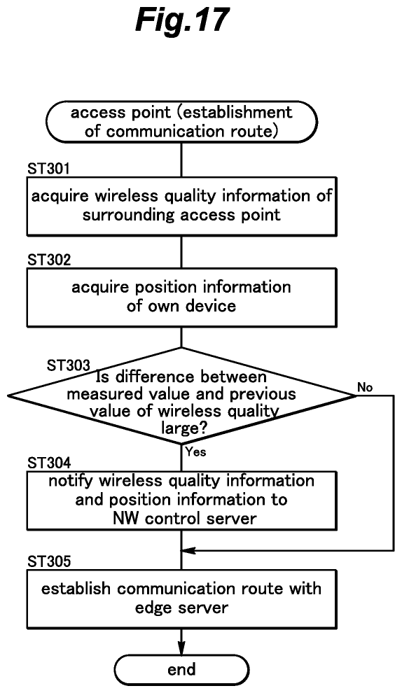

FIG. 17 is a flowchart showing a flow of processing in each access point 4 shown in FIG. 7.

First, the access point 4 measures the wireless quality with respect to another access point 4 around the own device and thereby acquires the wireless quality information (ST301). At this time, the measured value of the wireless quality (for example, the reception signal strength) is stored in the storage 24. Subsequently, the access point 4 acquires the position information of the own device (ST302).

Next, the access point 4 determines whether the difference between the measured value of the wireless quality in step ST301 and the previous measured value already stored in the storage 24 is greater than a preset threshold value (ST303). Note that in the determination in step ST303, the difference between the measured value of the wireless quality and a representative value (an average, a median, etc.) of the past measured values.

Then, when the difference between the measured values is greater than the threshold value (ST303: Yes), the access point 4 notifies wireless information including the measured value of the wireless quality to the NW control server 6 together with the position information acquired in step ST302 (ST304). Thereby, it is possible to avoid repeatedly notifying similar measured values (measured values with small differences) to the NW control server 6.

Thereafter, according to the route establishment instruction from the edge server 5, each access point 4 wirelessly connects to the access point 4 around it and establishes a communication route with the edge server 5 (ST305).

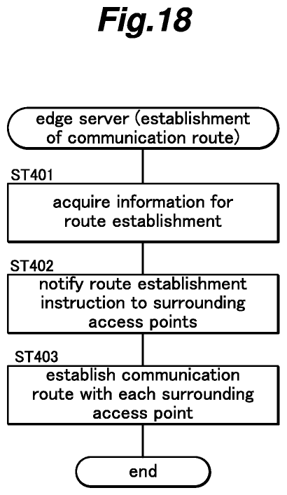

FIG. 18 is a flowchart showing a flow of processing in the edge server 5 shown in FIG. 7.

The edge server 5 acquires the information for route establishment (the group information, the route information) transmitted from the NW control server 6 (ST401). Subsequently, according to the information for route establishment, the edge server 5 notifies the route establishment instruction to each access point 4 around it forming the route (ST402). Thereafter, the edge server 5 establishes a communication route with each of these access points 4 (ST403).

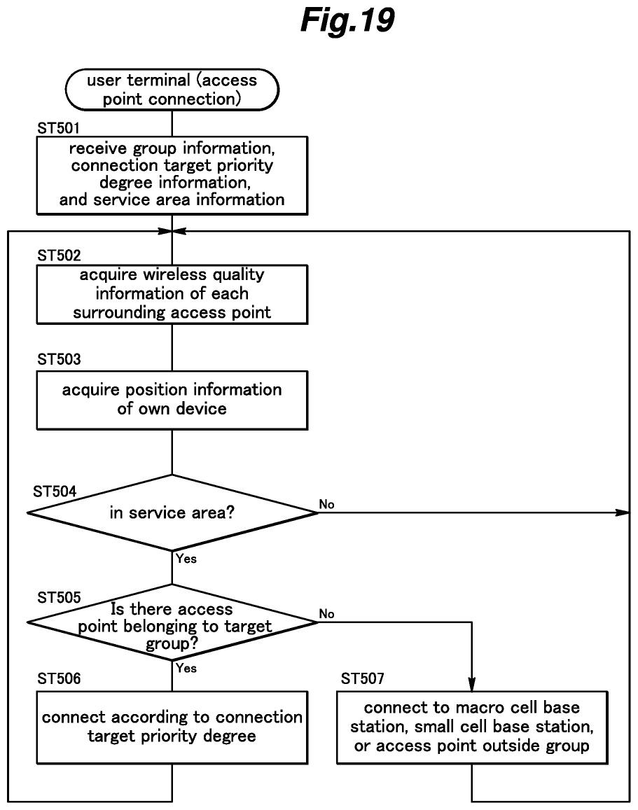

FIG. 19 is a flowchart showing a flow of processing in the user terminal 7 shown in FIG. 13.

The user terminal 7 acquires the group information, the connection target priority degree information, and the service area information from the NW control server 6 (ST501). Subsequently, based on the group information, the user terminal 7 measures the wireless quality with each access point 4 around the own device that qualifies as a connection target candidate and thereby acquires the wireless quality information (ST502). Further, the user terminal 7 measures the position of the own device and thereby acquires the position information (ST503).

Next, the user terminal 7 determines whether the own device is positioned in the service area of any of the access points 4 for which the wireless quality was measured in step ST502 (ST504). The user terminal 7 can perform the determination in step ST504 based on the service area information of step ST501 and the position information of step ST503.

Then, when it is determined in step ST504 that the own device is in the service area (Yes), the user terminal 7 further determines whether there is an access point 4 belonging to the target group, among the access points 4 having respective service areas in which the own device is present (ST505).

When it is determined in step ST505 that there is an access point 4 belonging to the target group around the user terminal 7 (Yes), the user terminal 7 connects to the access point 4 according to the priority degree of the connection target based on the connection target priority degree information (ST506).

On the other hand, when it is determined in step ST505 that there is not an access point 4 belonging to the target group around the user terminal 7 (No), the user terminal 7 connects to the macro cell base station 2, the small cell base station 3, or another access point 4 outside the target group (ST507).

### Second Embodiment

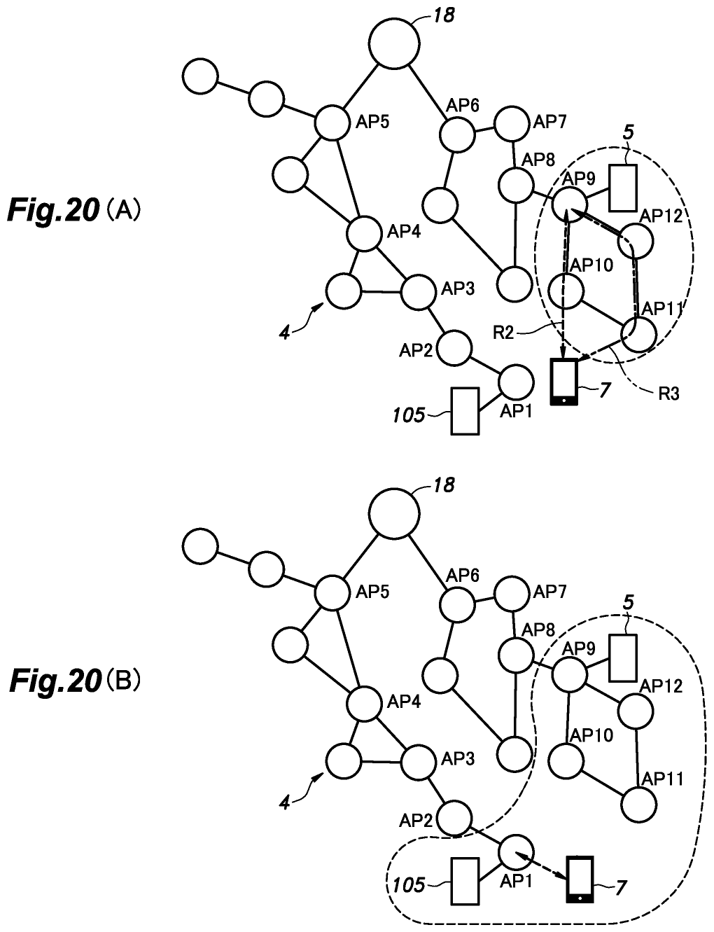

FIG. 20 is an explanatory diagram showing an example of activation control of an alternative edge server by the system 1 according to the second embodiment. FIG. 20(A) shows the communication routes constructed by the above-described system 1 according to the first embodiment, and substantially corresponds to FIG. 2(B). FIG. 20(B) shows a communication route constructed by the system 1 according to the second embodiment. Note that except for what will be particularly discussed in the following, the configuration of the system 1 according to the second embodiment is the same as the configuration of the first embodiment. Also, in the drawings for explaining the second embodiment, components similar to those of the system 1 according to the first embodiment will be denoted by identical reference signs.

As shown in FIG. 20(A), in the communication routes constructed by the system 1 according to the first embodiment, the access points AP9-AP12 including the access point AP9 to which the edge server 5 is connected are grouped, and the wireless communication routes R2, R3 are formed by the grouped access points AP9-AP12.

Even in the case where the wireless communication routes R2, R3 are thus formed, in the actual communication between the user terminal 7 and the edge server 5, there may be a case where a communication route including an access point outside the group (namely, the communication route passing the access points AP1-AP9) as shown in FIG. 2(A) is used at a constant rate.

Therefore, in the system 1 according to the second embodiment, when an alternative edge server 105 that can be an alternative to the edge server 5 is connected to such an access point outside the group (here, the access point AP1), a corresponding application on the alternative edge server 105 is activated. Further, in the system 1, as shown in FIG. 20(B), an access point outside the group (here, the access point AP1) is newly added to the group as necessary so that a communication route for connecting the user terminal 7 to the edge server 105 is constructed. Thereby, the user terminal 7 is enabled to use the alternative edge server 105 positioned around it, and therefore, the degree of freedom of selection of the communication routes is improved.

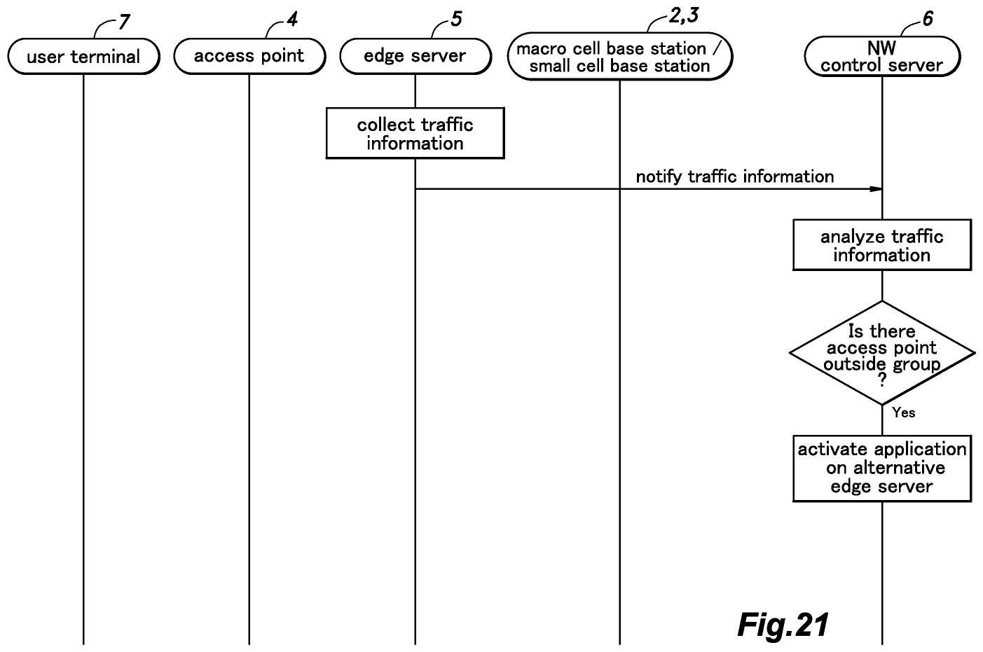

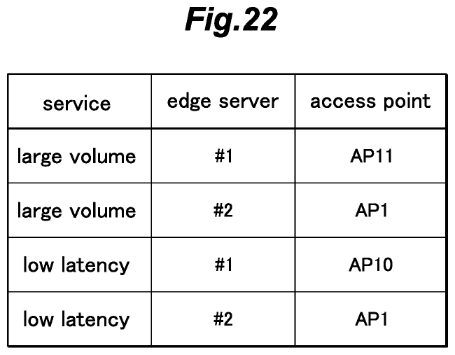

FIG. 21 is a sequence diagram showing a procedure of an activation operation of the alternative edge server 105 in the system 1. FIG. 22 is an explanatory diagram showing an example of alternative edge server information.

As shown in FIG. 21, in the system 1, the edge server 5 collects traffic information of the communication route used in the communication with the user terminal 7, and sequentially notifies this traffic information to the NW control server 6. The traffic information collected by the edge server 5 is based on the traffic sequentially notified from the access points 4.

The NW control server 6 accumulates the traffic information received from the edge server 5. Further, the NW control server 6 analyzes the traffic in the communication between the user terminal 7 and the edge server 5 based on the accumulated traffic information.

Then, when the NW control server 6 determines, as a result of such traffic analysis, that an access point 4 outside the group (for example, an access point not included in the group information shown in FIG. 14(A)) is included in the communication between the user terminal 7 and the edge server 5, the NW control server 6 activates a corresponding application of the alternative edge server 105 connected to the access point 4 outside the group. Here, the “corresponding application” is an application having a function similar to that of the application in the edge server 5 used by the user terminal 7.

At this time, instead of the group information shown in FIG. 14(A) (or together with the group information), the NW control server 6 transmits alternative edge server information including the information of the alternative edge server 105 to the user terminal 7.

As shown in FIG. 22 for example, the alternative edge server information includes the types of service of the edge server 5 that can be used by the user terminal 7 (here, large volume, low latency), the identifiers of the edge server 5 and the alternative edge server 105 corresponding to them (in FIG. 22, indicated by “#1,” “#2,” respectively), and the information of the access point (here, one of AP1, AP10, AP11 shown in FIG. 20) serving as the connection target for communicating with the edge server 5 and the alternative edge server 105.

FIG. 23 is a flowchart showing a flow of processing in the NW control server shown in FIG. 21.

The NW control server 6 analyzes the traffic in the communication between the user terminal 7 and the edge server 5 and thereby determines whether there is communication of the user terminal 7 using a detour route (namely, a communication route including an access point 4 outside the group) (ST601).

Next, when it is determined in step ST601 that there is communication using a detour route (Yes), the NW control server 6 determines whether the corresponding application can be activated on the alternative edge server 105 connected to an access point 4 present outside the group and configuring the detour route (ST602).

Subsequently, when it is determined in step ST602 that the application can be activated (Yes), the NW control server 6 makes the alternative edge server 105 activate the application (ST603).

Thereafter, the NW control server 6 resets the wireless communication route(s) by newly adding an access point(s) present outside the group and necessary for the connection between the user terminal 7 and the alternative edge server 105 to the group (ST604). At this time, the NW control server 6 updates the group information and the connection target priority degree information generated in the past.

On the other hand, when it is determined in step ST602 that the application cannot be activated (No), the NW control server 6 off loads the communication of the user terminal 7 to the macro cell (namely, transfers the communication of the user terminal 7 to the communication using the macro cell to distribute the communication of the user terminals 7) (ST605). Thereby, the user terminal 7 is connected to the edge server 5 via the macro cell base station 2.

### Third Embodiment

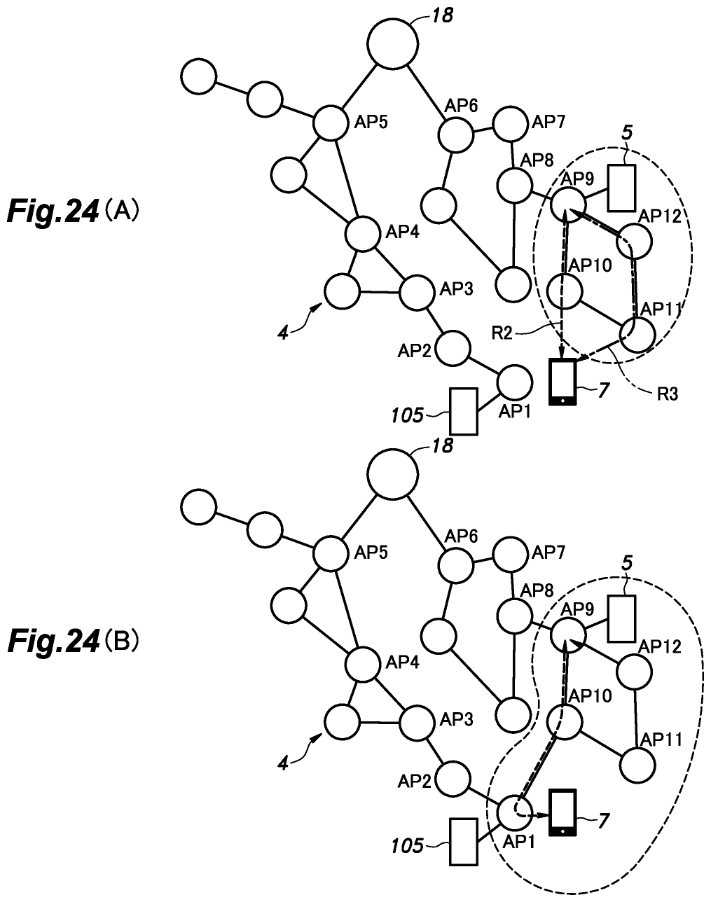

FIG. 24 is an explanatory diagram showing an example of access point addition control by the system 1 according to the third embodiment. FIG. 24(A) shows the communication routes constructed by the above-described system 1 according to the first embodiment and corresponds to FIG. 2(B). FIG. 24(B) shows a communication route constructed by the system 1 according to the third embodiment. Note that except for what will be particularly discussed in the following, the configuration of the system 1 according to the third embodiment is the same as the configuration of the first or second embodiment. Also, in the drawings for explaining the third embodiment, components similar to those of the system 1 according to the first or second embodiment will be denoted by identical reference signs.

As shown in FIG. 24(A), in the communication routes constructed by the system 1 according to the first embodiment, multiple access points AP9-AP12 including the access point AP9 to which the edge server 5 is connected are grouped, and the wireless communication routes R2, R3 are formed by the grouped access points AP9-AP12.

Even in the case where the wireless communication routes R2, R3 are thus formed, in the actual communication between the user terminal 7 and the edge server 5 there may be a case where a communication route including an access point outside the group (namely, the communication route passing the access points AP1-AP9) as shown in FIG. 2(A) is used at a constant rate.

Therefore, in the system 1 according to the third embodiment, as shown in FIG. 24(B), such an access point outside the group (here, the access point AP1) is added to the group, and constructs a new wireless communication route jointly with the existing access points 4 in the group. Thereby, in the system 1, the wireless communication route used in the communication between the edge server 5 and the user terminal 7 can be constructed more appropriately.

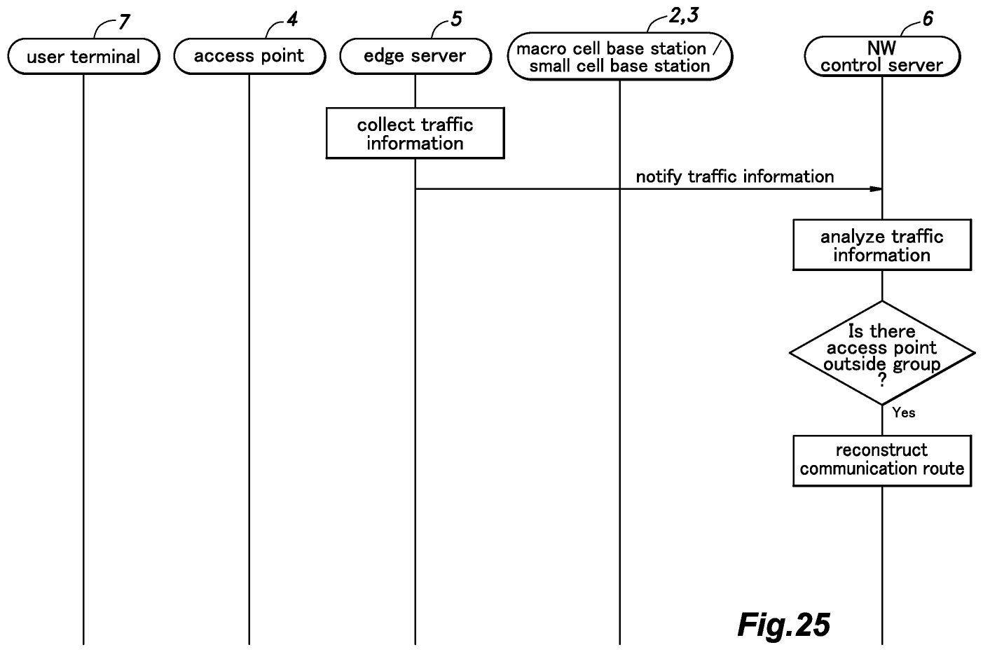

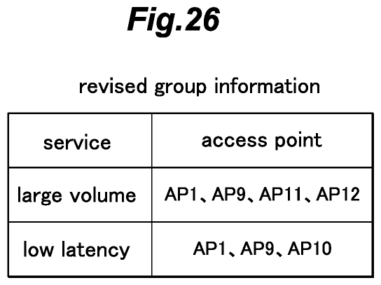

FIG. 25 is a sequence diagram showing a procedure of an access point addition operation by the system 1 according to the third embodiment. FIG. 26 is an explanatory diagram showing an example of revised group information.

In the system 1 shown in FIG. 25, as in FIG. 21, the edge server 5 sequentially notifies the traffic information to the NW control server 6. Also, the NW control server 6 analyzes the traffic in the communication between the user terminal 7 and the edge server 5 based on the accumulated traffic information.

Then, when the NW control server 6 determines, as a result of such traffic analysis, that an access point 4 outside the group is included in the communication between the user terminal 7 and the edge server 5, the NW control server 6 reconstruct the wireless communication route.

At this time, the NW control server 6 transmits revised group information obtained by revising (namely, updating) the group information shown in FIG. 14(A) to the user terminal 7.

As shown in FIG. 26 for example, in the revised group information, the access points 4 configuring the groups corresponding to the types of service that can be used by the user terminal 7 include the information of the new access point. Here, an example in which the new access point AP1 is added to the existing access points AP9-AP12 shown in FIG. 24 is shown.

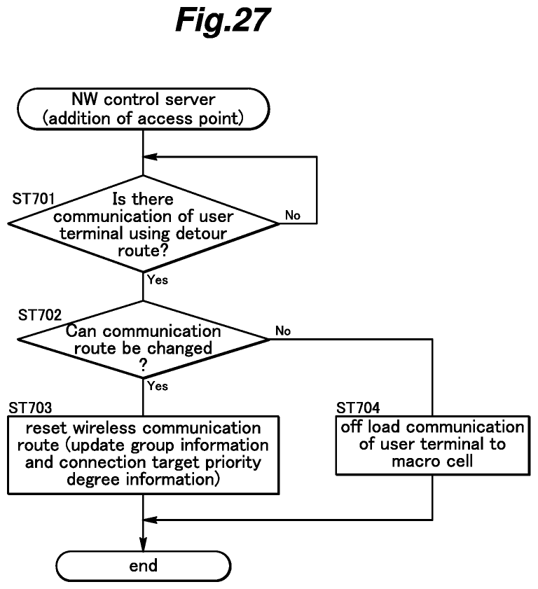

FIG. 27 is a flowchart showing a flow of processing in the NW control server shown in FIG. 25.

The NW control server 6 analyzes the traffic in the communication between the user terminal 7 and the edge server 5 and thereby determines whether there is communication of the user terminal 7 using a detour route (namely, a wireless communication route including an access point outside the group) (ST701).

Next, when it is determined in step ST701 that there is communication using the detour route (Yes), the NW control server 6 determines whether the communication route can be changed by using an access point(s) 4 present outside the group and configuring the detour route (ST702).

Subsequently, when it is determined in step ST702 that the communication route can be changed (Yes), the NW control server 6 resets the wireless communication route by newly adding an access point(s) outside the target group to the group (ST703).

On the other hand, when it is determined in step ST702 that the communication route cannot be changed (No), the NW control server 6 off loads the communication of the user terminal 7 to the macro cell (ST704). Thereby, the user terminal 7 is connected to the edge server 5 via the macro cell base station 2.

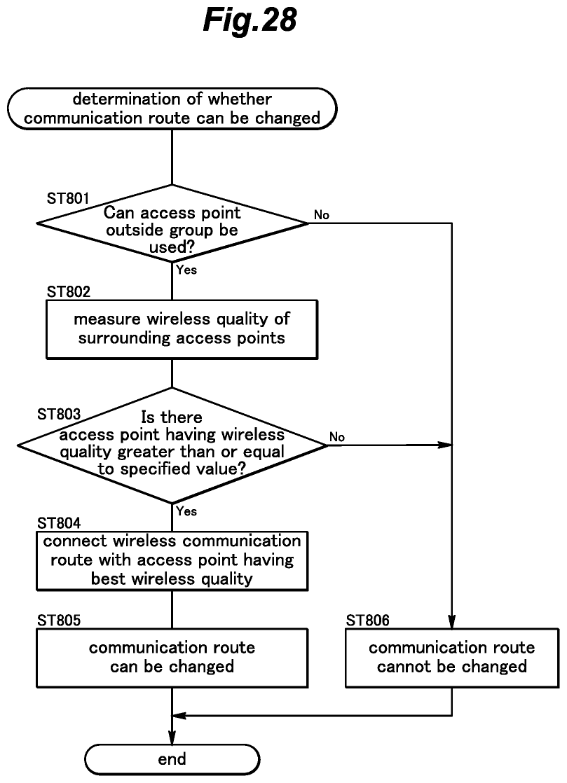

FIG. 28 is a flowchart showing details of a determination process on whether the communication route may be changed in step ST702 of FIG. 27.

First, the NW control server 6 determines whether any access point 4 present outside the group and included in the detour route can be used (ST801). This determination is performed based on usable resources (channels, band widths, transmission electric power, etc.) at each access point 4 for which the determination is performed, for example. Also, in step ST801, when any access point 4 for which the determination is performed is used by another terminal or the like, the NW control server 6 can determine that the access point 4 cannot be used.

When it is determined in step ST801 that the access point 4 can be used (Yes), the NW control server 6 makes the access point 4 measure the wireless quality with other access points 4 around it (ST802).

Then, when access points 4 having a wireless quality greater than or equal to a specified value are present in the target group (ST803: Yes), the NW control server 6 connects the wireless communication route between one of these access points 4 that has the best wireless quality and an access point 4 outside the group (ST804). Thereby, the NW control server 6 determines that the communication route can be changed (ST805).

On the other hand, when it is determined in step ST801 that the access points 4 cannot be used (No), the NW control server 6 determines that the communication route cannot be changed (ST806).

### Fourth Embodiment

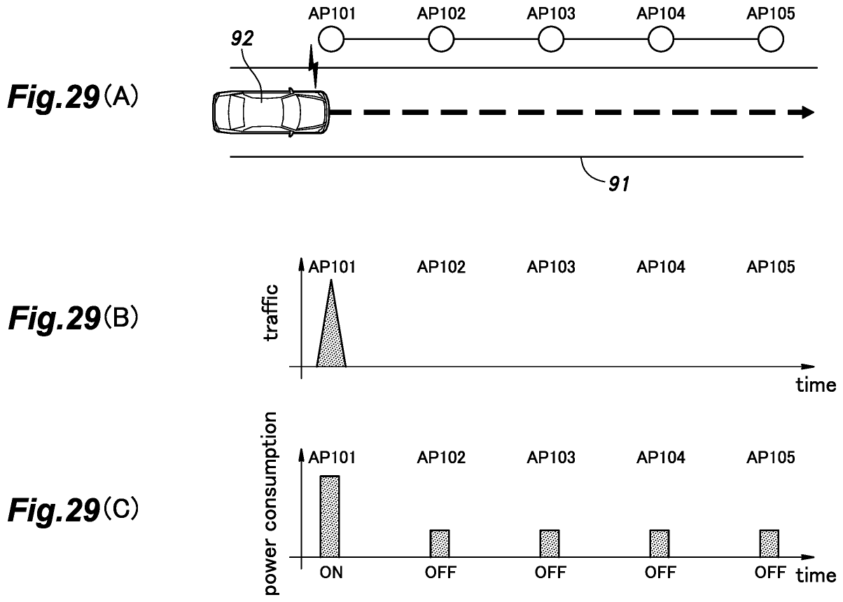

FIG. 29 is an explanatory diagram showing an example of a network in a specific area to which the system 1 according to the fourth embodiment is applied. Note that except for what will be particularly discussed in the following, the configuration of the system 1 according to the fourth embodiment is the same as the configuration of any of the first to third embodiments. Also, in the drawings for explaining the fourth embodiment, components similar to those of the system 1 according to any of the first to third embodiments will be de noted by identical reference signs.

As shown in FIG. 29(A), for example, in a case where the user terminal (not shown in the drawing) is installed in a vehicle 92 traveling on a road 91 and multiple access points (see reference signs AP101-AP105 in FIG. 29) are disposed along the road 91, the traffic of the communication between the user terminal and each access point AP101-AP105 changes depending on the travel position of the vehicle 92 (namely, lapse of time).

When the vehicle 92 is in the position shown in FIG. 29(A), as shown in FIG. 29(B), only the traffic of communication between the vehicle 92 (user terminal) and the access point AP101 occurs, and no traffic occurs at the other access points AP102-AP105 that are apart from the vehicle 92. On the other hand, the access points AP101-AP105 similarly consume electric power.

Therefore, in the system 1 according to the fourth embodiment, as shown in FIG. 29(C), the access point AP102-AP105 for which no traffic is generated are temporarily brought into the OFF state (standby state) until the time when they are used, for example. Thereby, in the system 1, the total power consumption of the access points AP101-AP105 can be suppressed compared to the case where the all access points AP101-AP105 are always in the ON state (activated state).

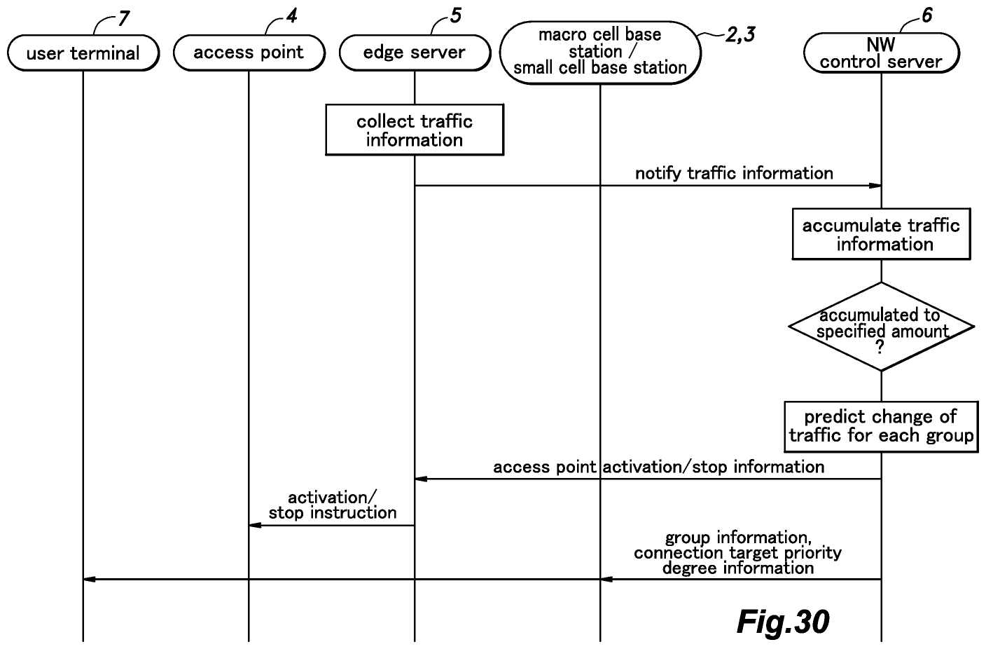

FIG. 30 is a sequence diagram showing a procedure of activation and stop operations of the access points in the system 1 according to the fourth embodiment.

As shown in FIG. 30, in the system 1, the edge server 5 collects traffic information of the communication route used in the communication with the user terminal 7, and sequentially notifies this traffic information to the NW control server 6. The traffic information collected by the edge server 5 is based on the traffic sequentially notified from the access points 4.

The NW control server 6 accumulates the traffic information received from the edge server 5. Then, when an amount of traffic information greater than or equal to a preset specified amount is accumulated, the NW control server 6 predicts the change of traffic for each group of access points 4. At this time, based on the predicted change of traffic of each access point 4, the NW control server 6 generates access point activation/stop information (activation command) including the activation and stop timing of each access point 4.

Then, the NW control server 6 transmits the generated access point activation/stop information to the edge server 5.

Upon receipt of the access point activation/stop information from the NW control server 6, the edge server 5 transmits activation/stop instruction to each access point 4 to individually activate or stop each access point 4.

Also, the NW control server 6 transmits the group information and the connection target priority degree information updated according to the activation and stop of each access point to the user terminal 7.

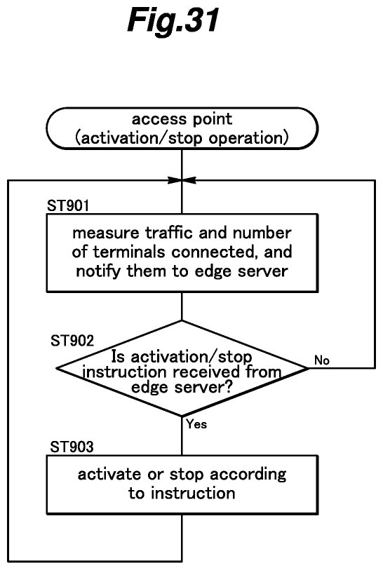

FIG. 31 is a flowchart showing a flow of processing in the access point 4 shown in FIG. 30.

The access point 4 measures the traffic between itself and another access point 4 around it and the number of user terminals 7 connected to the own device, and notifies the measurement result to the edge server 5 (ST901). Thereby, the edge server 5 can collect traffic information.

Thereafter, upon receipt of the activation/stop instruction from the edge server 5 (ST902: Yes), the access point 4 activates or stops the own device according to the instruction (ST903).

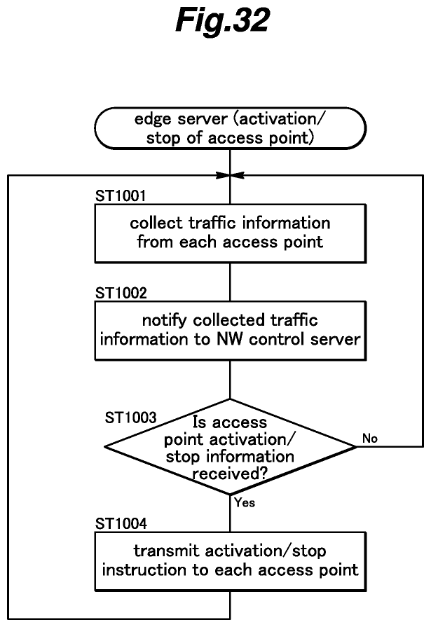

FIG. 32 is a flowchart showing a flow of processing in the edge server 5 shown in FIG. 30.

The edge server 5 collects traffic information from each access point 4 in the communication route used in the communication with the user terminal 7 (ST1001). Subsequently, the edge server 5 notifies the collected traffic information to the NW control server 6 (ST1002).

Thereafter, upon receipt of the access point activation/stop information from the NW control server 6 (ST1003: Yes), the edge server 5 transmits activation/stop instruction to each access point 4 to individually activate or stop each access point 4 according to the access point activation/stop information (ST1004). Thereby, each access point 4 activates or stops the own device according to the activation/stop instruction at the timing instructed by the edge server 5.

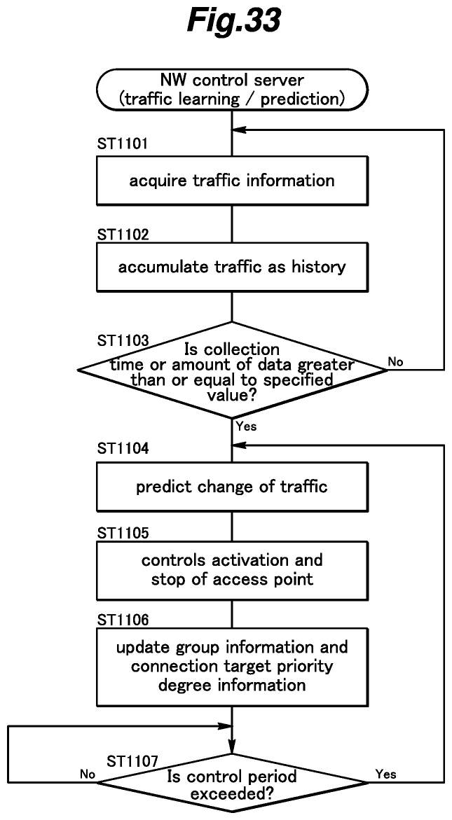

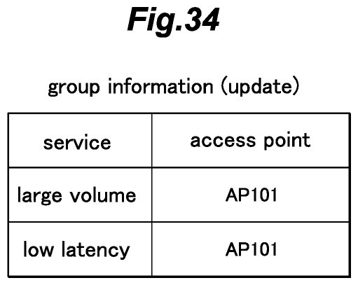

FIG. 33 is a flowchart showing a flow of processing in the NW control server 6 shown in FIG. 30. FIG. 34 is an explanatory diagram showing group information updated in step ST1106 of FIG. 33.

The NW control server 6 acquires the traffic information at each access point 4 from the edge server 5 (ST1101), and accumulates the acquired traffic as history (ST1102).

Next, when at least one of the collection time (elapsed time from the collection start) of the traffic and the amount of data of the traffic becomes greater than or equal to a respective specified value (ST1103: Yes), the NW control server 6 predicts the change of traffic of each group of access points 4 (ST1104).

Subsequently, based on the change of traffic predicted in step ST1104, the NW control server 6 controls activation and stop of each access point 4 (ST1105). At this time, the NW control server 6 generates access point activation/stop information including the activation and stop timing of each access point 4 and transmits the same to the edge server 5.

Thereafter, the NW control server 6 updates the group information and the connection target priority degree information according to the activation and stop of the respective access points (ST1106). The updated group information and connection target priority degree information are transmitted to the user terminal 7. Thereby, the user terminal 7 can select the access point 4 serving as the connection target by using the updated information.

As shown in FIG. 34 for example, the update group information includes only the access point that is activated (for example, the access point AP101 shown in FIG. 29) and the other access points AP102-105 in the standby state are temporarily excluded.

Such processing in the NW control server 6 is executed at a predetermined control period. When the NW control server 6 determines that the predetermined control period is exceeded (ST1107: Yes), the NW control server 6 returns to step ST1102 and executes the same processing.

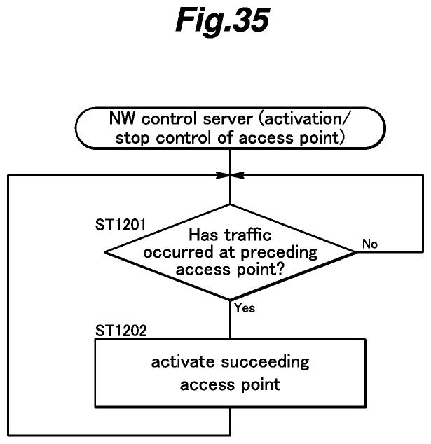

FIG. 35 is a flowchart showing a flow of activation and stop control of the access point in step ST1105 of FIG. 33.

The NW control server 6 determines whether traffic has occurred at a preceding access point (ST1201). Here, the preceding access point is an access point where traffic can occur at an earlier timing, and can be a reference for the timing of activation of a succeeding access point (namely, an access point where traffic occurs later). Note that the preceding access point does not necessarily have to belong to the same group as the succeeding access point.

When it is determined in step STST1201 that traffic has occurred at a specific access point, the NW control server 6 activates the succeeding access point (ST1202).

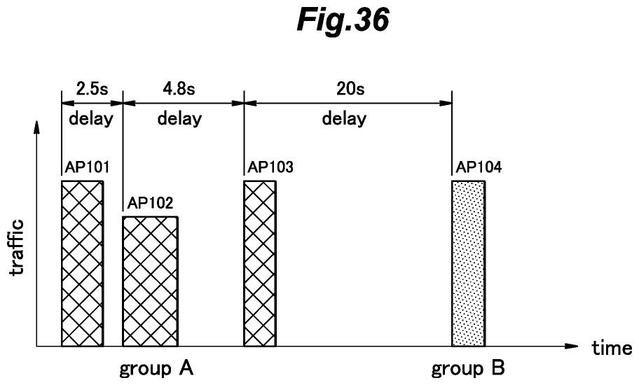

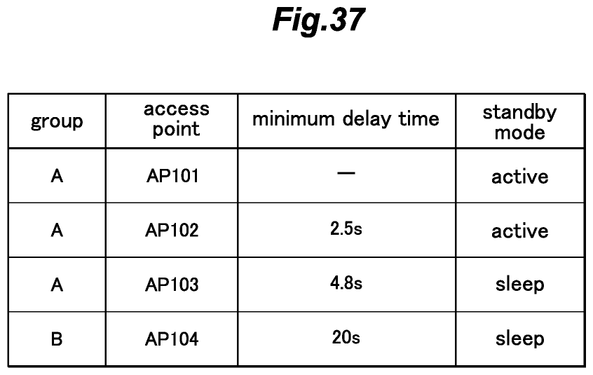

FIG. 36 is an explanatory diagram showing an example of traffic distribution in the access points 4 according to the fourth embodiment. FIG. 37 is an explanatory diagram showing an example of a relationship between a minimum delay time and a standby mode in each access point 4 according to the fourth embodiment.

The arrangement of access points and the traffic distribution thereof may not be always uniform as in the case shown in FIG. 29(B). For example, as shown in FIG. 36 for example, occurrence time intervals of traffic between the access points AP101-AP104 and the continuation time periods thereof may differ from one another.

Also, since it requires a certain time (here, 3 sec) from the start to completion of activation of each access point AP101-AP104, if the activation of the succeeding access point is started after the communication start (or activation) of the preceding access point (namely, an access point to be activated earlier) is confirmed, the activation of the succeeding access point may not be completed at the timing when the communication with the user terminal 7 is required.

In the example shown in FIG. 36, the traffic of the succeeding access point AP102 occurs after 2.5 sec from when the traffic of the preceding access point AP101 occurs (namely, the communication with the user terminal 7 is started). Therefore, if the access point AP102 starts the activation after the communication start of the access point AP101 is confirmed, the activation will not be completed at the timing when the communication with the user terminal 7 is required.

On the other hand, the traffic of the access point AP103 occurs after 4.8 sec from the occurrence of the traffic of the preceding access point AP102. Therefore, even if the access point AP103 starts the activation after confirming the communication start of the access point AP102, the activation will be completed before the traffic of the own device occurs.

Similarly, the access point AP104 belongs to group B which is different from group A to which the preceding access point AP103 belongs, and the traffic thereof occurs after 20 sec from the occurrence of the traffic of the access point AP102. Therefore, even if the access point AP104 starts the activation after confirming the communication start of the access point AP103, the activation will be completed before the traffic of the own device occurs.

Thereby, in the system 1, as shown in FIG. 37 for example, the standby mode of each access point AP101-AP104 is set corresponding to the minimum delay time thereof. Here, the minimum delay time is the minimum prediction time from when the traffic of the preceding access point occurs to when the traffic of the own device occurs. Also, “active” of the standby mode indicates that the access point is in the activated state, “sleep” indicates that the access point is in the temporarily stopped state (namely, can stand by until the preceding access point starts communication). The NW control server 6 can control activation and stop of each access point AP101-AP104 according to the setting of the standby mode as shown in FIG. 37.

In the foregoing, description was made of embodiments to illustrate the technology disclosed in the present application. However, the technology of the present disclosure is not limited to them and may be applied to embodiments which may include change, replacement, addition, omission, etc. Also, new embodiments may be made by combining the components described with respect to the above embodiments.

For example, though the communication between the user terminal 7 and the edge server 5 is realized by a wireless communication route based on wireless communication between the access points 4 as described above, the present disclosure does not exclude using wired communication in a part of the communication route used in the communication between the user terminal 7 and the edge server 5.

### INDUSTRIAL APPLICABILITY

The network control device, network control system, and network control method according to the present disclosure have an effect that, in a network having an edge server disposed therein, a wireless communication route used in the communication between the edge server and the user terminal can be appropriately constructed, and are useful as a network control device, a network control system, and a network control method for controlling a communication route in a network and the like.

### LIST OF REFERENCE NUMERALS

1 network control system
2 macro cell base station
3 small cell base station
4 access point (base station)
5 edge server
6 NW control server (network control device)
7 user terminal
9 core network
11 small cell area
12 macro cell area
13 communication area
15 core network

### 16 Internet

18 connection point
21 wireless communicator
22 backhaul communicator
23 wired communicator
24 storage
25 controller
31 wireless quality measurer
32 position information acquirer
33 route connector
34 wireless communication controller
35 wired communication controller
41 communicator
42 storage
43 controller
45 route establishment instructor
46 traffic information collector
47 access point operation instructor
48 communication controller
49 application unit
51 communicator
52 storage
53 controller (processor)
61 information collector
62 grouping unit
63 route setter
64 traffic analyzer
65 connection target priority degree setter
66 service area setter
67 edge server operation controller
68 access point operation controller
69 communication controller
71 wireless communicator
72 storage
73 position information acquirer
74 controller
81 connection target selector
82 application unit
83 wireless communication controller
85 service provision area
86A communicable area
86B communicable area
86C communicable area
91 road
92 vehicle
105 alternative edge server

1. A network control device comprising a processor that executes a process for controlling a communication route between an edge server and a user terminal in a network, wherein the network comprises multiple base stations and the edge server is connected to one of the base stations,
and wherein the processor
acquires group information related to grouped base stations in the multiple base stations,
acquires route information related to one or more wireless communication routes formed by multi-hop communication between the grouped base stations, and
transmits the group information and the route information to the edge server or the user terminal.

2. The network control device according to claim 1, wherein the processor acquires wireless quality information related to quality of wireless communication between each pair of base stations in the multiple base stations, position information of each base station, and edge server information related to presence or absence of the edge server connected to each base station, and
generates the group information and the route information based on the wireless quality information, the position information, and the edge server information.

3. The network control device according to claim 1, wherein the route information includes information related to multiple wireless communication routes, and
the processor acquires connection target priority degree information related to a priority degree of a connection target of the user terminal set according to a type of service of the edge server used by the user terminal and transmits the connection target priority degree information to the user terminal.

4. The network control device according to claim 1, wherein the processor transmits, to the user terminal, service area information related to a distance from the base station set in accordance with the type of service of the edge server used by the user terminal.

5. The network control device according to claim 1, wherein the processor
acquires traffic information of a wireless communication route used in communication between the edge server and the user terminal, and
updates the group information based on the traffic information.

6. The network control device according to claim 1, wherein the processor generates the route information so as to minimize a number of hops between the grouped base stations according to a type of service of the edge server used by the user terminal.

7. The network control device according to claim 1, wherein the processor generates the route information to maximize electric power efficiency of communication using the wireless communication route according to a type of service of the edge server used by the user terminal.

8. The network control device according to claim 1, wherein the processor
acquires traffic information of a wireless communication route used in communication between the edge server and the user terminal, and
when it is determined, based on the traffic information, that an alternative edge server which can be an alternative to the edge server is connected to another base station other than the grouped base stations, activates an application program that can be used by the user terminal on the alternative edge server.

9. The network control device according to claim 1, wherein the processor acquires traffic information of a wireless communication route used in communication between the edge server and the user terminal, and
when it is determined, based on the traffic information, that another base station other than the grouped base stations is used in the communication between the edge server and the user terminal, adds the another base station to the grouped base stations.

10. The network control device according to claim 1, wherein the processor
acquires traffic information of a wireless communication route used in communication between the edge server and the user terminal, and
transmits an activation command for activating and stopping the grouped base stations to the edge server based on the traffic information.

11. A network control system comprising: the network control device according to claim 1; the multiple base stations; and the one or more edge servers.

12. A network control method for controlling a communication route between an edge server and a user terminal in a network, wherein the network comprises multiple base stations and the edge server is connected to one of the base stations,
the method comprising:
acquiring group information related to grouped base stations of the multiple base stations;
acquiring route information related to one or more wireless communication routes formed by multi-hop communication between the grouped base stations; and
transmitting the group information and the route information to the edge server or the user terminal.
